(19) United States
(12) Patent Application Publication
(10) Pub. No.: US 2024/0139722 A1
(43) Pub. Date: May 2, 2024

(54) ORGANO-PHOSPHATE MODIFIED METAL ORGANIC FRAMEWORKS AND APPLICATIONS

(71) Applicant: The Johns Hopkins University, Baltimore, MD (US)

(72) Inventors: Michael TSAPATSIS, Baltimore, MD (US); Efrosini KOKKOLI, Baltimore, MD (US); Danyu WANG, Baltimore, MD (US)

(21) Appl. No.: 18/495,958

(22) Filed: Oct. 27, 2023

Related U.S. Application Data
(60) Provisional application No. 63/381,308, filed on Oct. 28, 2022.

(51) Int. Cl. B01J 31/16; C08G 83/00

(52) U.S. Cl. CPC B01J 31/1691; C08G 83/008; B01J 2231/326; B01J 2231/348; B01J 2231/4205

(57) ABSTRACT

Disclosed is a method to modify metal-organic frameworks (MOFs) by irreversible adsorption of nucleotides including, but not limited to, adenosine triphosphate (ATP), guanosine triphosphate (GTP), deoxyadenosine triphosphate (dATP), adenosine diphosphate (ADP), and adenosine monophosphate (AMP), the modified MOFs, and the use of the modified MOFs as adsorbents and catalysts.

### CROSS-REFERENCE TO RELATED APPLICATIONS

This application claims the benefit of U.S. Provisional Application No. 63/381,308, filed Oct. 28, 2022, the contents of which is incorporated herein by reference in its entirety.

### TECHNICAL FIELD

This application relates modified metal-organic frameworks that have potential as a new class of enantioselective heterogeneous catalysts.

### BACKGROUND

Metal-organic frameworks (MOFs), a class of crystalline porous materials comprising inorganic clusters and organic linkers, find uses in numerous applications including catalysis, adsorption, sensors, and membranes due to their superior performance relative to current commercially available materials. MOFs are highly tunable and diverse in their molecular structures and chemical compositions with well-defined pore sizes ranging from a few angstroms to several nanometers in diameter. For example, MIL-101 was discovered by Fèrey and co-workers [1] and has proven to be a highly stable prototypical MOF with numerous potential applications including heterogeneous catalysis [2, 3]. Its large pores of 2.9 nm and 3.4 nm, that can be accessed through relatively large windows of 1.2-1.4 nm (FIG. 1A), and the presence of open metal coordination sites are attractive features for incorporation of catalytic sites. Post-synthetic modification of MIL-101 can lead to new properties, as has been reviewed in Zorainy [4]. For example, Kim and co-workers, using chiral organic ligands, achieved enantioselectivities in aldol reactions [5].

Although numerous modifications of MIL-101 and other MOFs have been reported, there is no known teaching in the art relating to the modification of MIL-101 (or other MOFs) with adenosine triphosphate (ATP) and related molecules including adenosine monophosphate (AMP), adenosine diphosphate (ADP), deoxyadenosine triphosphate (dATP) and guanosine triphosphate (GTP). These molecules (see, e.g., FIG. 1) play an important role in biology and because they are chiral, they may introduce chiral recognition capabilities to the MOFs.

It is known that DNA can adsorb on the outside surface of MOF crystals [6] and has been used to direct MOF assembly [7]. More recently, the adsorption of short DNA sequences in MOF pores has been demonstrated [8, 9]. Although DNA binding to MOF nanoparticles by coordination bonds between the phosphate groups of the DNA backbone and the metal ions of the MOF has been confirmed [7], ATP and other nucleotide adsorption on MOFs has not been studied. Even studies specifically dedicated to the construction of systems that can function as selective ATP sensors do not demonstrate ATP adsorption [10, 11]. In another study, AMP was used in the synthesis of zeolitic imidazolate frameworks (ZIFs) and was shown to be incorporated in the ZIF, creating mesoporosity and improved acid stability, and facilitating the encapsulation and function of enzymes [12]. That said, the adsorption of nucleotides in a formed MOF or ZIF has not been demonstrated. Moreover, adsorption of nucleotides in MOFs without loss of MOF crystallinity has not been demonstrated.

It would be an advance in the arts to provide an adsorption-based method to create a new class of enantioselective heterogeneous catalysts, as well as the use of irreversible nucleotide adsorption as a post-synthetic modification method of the structure and catalytic and adsorption properties of MOFs.

### SUMMARY

In some aspects, the present invention relates to a method for adsorbing at least one organophosphate in and/or on a parent metal-organic frameworks (MOFs), said method comprising:
contacting at least one parent MOF with an aqueous solution comprising at least one organophosphate for a time and at a temperature necessary to effectuate substantial adsorption of the at least one organophosphate in and/or on the parent MOFs to produce modified MOFs; and
washing the modified MOFs with water to remove any non-adsorbed organophosphates.

In some other aspects, the present invention relates to a method for adsorbing at least one nucleotide in and/or on a parent metal-organic frameworks (MOFs), said method comprising:
contacting at least one parent MOF with an aqueous solution comprising at least one nucleotide for a time and at a temperature necessary to effectuate substantial adsorption of the at least one organophosphate in and/or on the parent MOFs to produce modified MOFs; and
washing the modified MOFs with water to remove any non-adsorbed organophosphates.

In yet another aspect, the present invention relates to a method for adsorbing at least one organophosphate in and/or on a parent metal-organic frameworks (MOFs), said method comprising:
contacting at least one parent MOF with an aqueous solution comprising at least one organophosphate and at least one metal ion for a time and at a temperature necessary to effectuate substantial adsorption of the at least one organophosphate in and/or on the parent MOFs to produce modified MOFs; and
washing the modified MOFs with water to remove any non-adsorbed organophosphates.

In still another aspect, the present invention relates to a method for adsorbing at least one nucleotide in and/or on a parent metal-organic frameworks (MOFs), said method comprising:
contacting at least one parent MOF with an aqueous solution comprising at least one nucleotide and at least one metal ion for a time and at a temperature necessary to effectuate substantial adsorption of the at least one organophosphate in and/or on the parent MOFs to produce modified MOFs; and
washing the modified MOFs with water to remove any non-adsorbed organophosphates.

In yet another aspect, the present invention relates to a modified metal-organic framework (MOF) comprising at least one MOF and at least one irreversibly adsorbed organophosphate.

In another aspect, the present invention relates to a modified metal-organic framework (MOF) comprising at least one MOF and at least one irreversibly adsorbed nucleotide.

In still another aspect, the present invention relates to a modified metal-organic framework (MOF) comprising at least one MOF, at least one metal ion, and at least one irreversibly adsorbed organophosphate.

In another aspect, the present invention relates to a modified metal-organic framework (MOF) comprising at least one MOF, at least one metal ion, and at least one irreversibly adsorbed nucleotide.

In still another aspect, the present invention relates to a method of using a modified MOF as a catalyst for enantio-selective reactions, wherein the modified MOF comprises at least one MOF, at least one metal ion, and at least one irreversibly adsorbed organophosphate.

In yet another aspect, the present invention relates to a method of using a modified MOF as a catalyst for enantio-selective reactions, wherein the modified MOF comprises at least one MOF, at least one metal ion, and at least one irreversibly adsorbed nucleotide.

In another aspect, the present invention relates to the use of a modified MOF as an adsorbent material to adsorb water, wherein the modified MOF comprises at least one MOF, optionally at least one metal ion, and at least one irreversibly adsorbed organophosphate.

In another aspect, the present invention relates to the use of a modified MOF as an adsorbent material to adsorb water, wherein the modified MOF comprises at least one MOF, optionally at least one metal ion, and at least one irreversibly adsorbed nucleotide.

In another aspect, the present invention relates to the use of a modified MOF as an adsorbent material to adsorb copper ions, wherein the modified MOF comprises at least one MOF, and at least one irreversibly adsorbed organophosphate.

In another aspect, the present invention relates to the use of a modified MOF as an adsorbent material to adsorb copper ions, wherein the modified MOF comprises at least one MOF, and at least one irreversibly adsorbed nucleotide.

In another aspect, the present invention relates to the use of a modified MOF as an adsorbent material to adsorb chiral molecules for enantioselective separations, wherein the modified MOF comprises at least one MOF, optionally at least one metal ion, and at least one irreversibly adsorbed organophosphate.

In another aspect, the present invention relates to the use of a modified MOF as an adsorbent material to adsorb chiral molecules for enantioselective separations, wherein the modified MOF comprises at least one MOF, optionally at least one metal ion, and at least one irreversibly adsorbed nucleotide.

Other aspects, features and embodiments of the invention will be more fully apparent from the ensuing disclosure and appended claims.

### BRIEF DESCRIPTION OF THE FIGURES

The patent or application file contains at least one drawing executed in color. Copies of this patent or patent application publication with color drawings will be provided by the Office upon request and payment of the necessary fee.

Having thus described the presently disclosed subject matter in general terms, reference will now be made to the accompanying Figures, which are not necessarily drawn to scale, and wherein:

FIG. 1A. Ball-and-stick model of pentagonal and hexagonal windows, Cr₃ node, super-tetrahedron face, and the two cages of MIL-101(Cr). Chromium octahedra, oxygen, fluorine and carbon atoms are in green, red, red and grey, respectively.

FIG. 1B. Adsorption of ATP in MIL-101(Cr) at 4° C. from ATP-water solutions; the x-axis indicates the final concentration of ATP, after adsorption is complete.

FIG. 1C. Remaining amount of ATP adsorbed in MIL-101(Cr) after 0-3 washings at 4° C. with water. The sample used for the washing experiments is circled in FIG. 1B.

FIG. 1D. XRD patterns of MIL-101(Cr) and ATP-MIL-101(Cr), λ=0.45199 Å.

FIG. 1E. Difference density map of ATP-MIL-101(Cr) calculated from the refinement of MIL-101(Cr).

FIG. 2A. SEM image of MIL-101(Cr).

FIG. 2B. SEM image of ATP-MIL-101(Cr).

FIG. 3A. N₂ adsorption isotherms of MIL-101(Cr) (black) and ATP-MIL-101(Cr) (red) at 77 K with calculated pore volumes of 1.42 cm³/g MIL-101(Cr) and 1.22 cm³/g ATP-MIL-101(Cr), respectively.

FIG. 3B. Water adsorption/desorption isotherms of two regeneration cycles for MIL-101(Cr) at 25° C.

FIG. 3C. Water adsorption/desorption isotherms of two regeneration cycles for ATP-MIL-101(Cr) at 25° C.

FIG. 4. Absolute configurations of endo and exo isomers of the Diels-Alder product 3.

FIG. 5. Conversion and ee for Diels—Alder reaction catalyzed by MIL-101(Cr), Cu(II)-MIL-101(Cr), homogeneous catalyst Cu(II)-ATP, heterogenized catalyst Cu(II)-ATP-MIL-101(Cr) or heterogenized catalyst Cu(II)-ATP-MIL-101(Cr)* prepared by an alternative procedure in MES (20 mM, pH 5.5) at 4° C. for 3 h. Cu(OTf)₂: 50 μM; ATP: 250 μM; MIL-101(Cr): 1 mg/mL; aza-chalcone (1): 1 mM (i.e., 5% catalyst loading); cyclopentadiene (2): 16 μL (200 equiv). All data were averaged over three independent experiments.

FIG. 6A. pH effect on Diels-Alder reaction catalyzed by homogeneous catalyst Cu(II)-ATP. Conversion and ee for Diels—Alder reaction catalyzed by homogeneous catalyst Cu(II)-ATP in “no buffer” (pure Milli-Q water), “MES*” (MES: 20 mM, without pH adjustment, initial pH=3.3), “MES, pH=5.5” (MES: 20 mM, pH=5.5 adjusted by NaOH), “MES, pH=6.5” (MES: 20 mM, pH=6.5 adjusted by NaOH) or “PB, pH=6.5” (phosphate buffer: 20 mM, pH=6.5 adjusted by NaOH) at 4° C. for 3 h. Same reaction conditions as in FIG. 5. The data for “MES, pH=5.5” were the same as the data in FIG. 5. All data were averaged over three independent experiments.

FIG. 6B. pH effect on Diels-Alder reaction catalyzed by heterogenized catalyst Cu(II)-ATP-MIL-101(Cr). Conversion and ee for Diels-Alder reaction catalyzed by heterogenized catalyst Cu(II)-ATP-MIL-101(Cr) in “no buffer” (pure Milli-Q water), “MES*” (MES: 20 mM, without pH adjustment, initial pH=3.3), “MES, pH=5.5” (MES: 20 mM, pH=5.5 adjusted by NaOH), “MES, pH=6.5” (MES: 20 mM, pH=6.5 adjusted by NaOH) or “PB, pH=6.5” (phosphate buffer: 20 mM, pH=6.5 adjusted by NaOH) at 4° C. for 3 h. Same reaction conditions as in FIG. 5. The data for “MES, pH=5.5” were the same as the data in FIG. 5. All data were averaged over three independent experiments.

FIG. 7. Conversion and ee for Diels—Alder reaction catalyzed by homogeneous catalyst Cu(II)-ATP or heterogenized catalyst Cu(II)-ATP-MIL-101(Cr) in MES (20 mM, pH 5.5) at 4° C. for 2 days. ee=(moles of Si-endo−moles of Re-endo)/(moles of Si-endo+moles of Re-endo)×100%. Cu(OTf)₂: 50 μM; ATP: 250 μM; MIL-101(Cr): 1 mg/mL; α,β-unsaturated 2-acyl imidazole (4): 1 mM (i.e., 5% catalyst loading); cyclopentadiene (2): 16 μL (200 equiv). MIL-101(Cr) exhibits no observable catalytic activity under the condition and time tested. All data are averaged over three independent experiments.

FIG. 8A. Conversion and ee for Diels—Alder reaction catalyzed by homogeneous catalyst Cu(II)-ATP or heterogenized catalyst Cu(II)-ATP-MIL-101(Cr) in MES (20 mM, pH 5.5) at 4° C. for 3 h. Cu(OTf)₂: 50 μM; ATP: 250 μM; MIL-101(Cr): 1 mg/mL; NO₂-modified aza-chalcone (1a): 1 mM (i.e., 5% catalyst loading); cyclopentadiene (2): 16 μL (200 equiv). All data were averaged over three independent experiments.

FIG. 8B. Conversion and ee for Diels—Alder reaction catalyzed by homogeneous catalyst Cu(II)-ATP or heterogenized catalyst Cu(II)-ATP-MIL-101(Cr) in MES (20 mM, pH 5.5) at 4° C. for 3 h. Cu(OTf)₂: 50 μM; ATP: 250 μM; MIL-101(Cr): 1 mg/mL; (2E)-3-Phenyl-1-(pyridin-4-yl)prop-2-en-1-one (1b): 1 mM (i.e., 5% catalyst loading); cyclopentadiene (2): 16 μL (200 equiv). All data were averaged over three independent experiments.

FIG. 9A. Conversion and ee for Diels—Alder reaction in MES (20 mM, pH 5.5) at 4° C. for 3 h. Cyclopentadiene (2): 1.6 μL (20 equiv). Same other reaction conditions as in FIG. 5. MIL-101(Cr) exhibits no observable catalytic activity under the condition and time tested. All data are averaged over three independent experiments.

FIG. 9B. Conversion and ee for Diels—Alder reaction in MES (20 mM, pH 5.5) at 4° C. for 12 h. Cyclopentadiene (2): 0.16 μL (2 equiv). Same other reaction conditions as in FIG. 5. MIL-101(Cr) exhibits no observable catalytic activity under the condition and time tested. All data are averaged over three independent experiments.

FIG. 10. Conversion and ee for Diels—Alder reaction in MES (20 mM, pH 5.5) at 4° C. for 12 h. aza-chalcone (1): 5 mM (i.e., 1% catalyst loading); cyclopentadiene (2): 80 μL (200 equiv). Same other reaction conditions as in FIG. 5. MIL-101(Cr) exhibits no observable catalytic activity under the condition and time tested in all cases. See experimental section (SI) for reaction procedure details. All data are averaged over three independent experiments. MIL-101(Cr) exhibits no observable catalytic activity under the condition and time tested. All data are averaged over three independent experiments.

FIG. 11. Catalyst reuse in water and performance in methanol. Conversion and ee for Diels—Alder reaction catalyzed by heterogenized catalyst Cu(II)-ATP-MIL-101(Cr) in MES (20 mM, pH 5.5) at 4° C. for 12 h for 4 runs. Same reaction conditions as in FIG. 5. All data are averaged over three independent experiments.

FIG. 12. Catalyst reuse in water and performance in methanol. Conversion and ee for Diels—Alder reaction catalyzed by no catalyst, dmbipy-Cu bound st-DNA, Cu(II)-ATP or Cu(II)-ATP-MIL-101(Cr) in methanol at 4° C. for 2 days. dmbipy-Cu: 50 μM; st-DNA: 50 μM; Cu(OTf)₂: 50 μM; ATP: 250 μM; MIL-101(Cr): 1 mg/mL; aza-chalcone (1): 1 mM (i.e., 5% catalyst loading); cyclopentadiene (2): 16 μL (200 equiv). All data are averaged over three independent experiments.

FIG. 13. Catalytic performance of ATP adsorbed on NU-1000. Conversion and ee for Diels—Alder reaction catalyzed by NU-1000(Zr) or Cu(II)-ATP-NU-1000(Zr) in MES (20 mM, pH 5.5) at 4° C. for 3 h. Cu(OTf)₂: 50 μM; ATP: 250 μM (66% of ATP was adsorbed in NU-1000(Zr)); NU-1000(Zr): 1 mg/mL; aza-chalcone (1): 1 mM (i.e., 5% catalyst loading); cyclopentadiene (2): 16 μL (200 equiv). All data are averaged over three independent experiments.

FIG. 14. Catalytic performance of ATP adsorbed on MOF-808. Conversion and ee for Diels—Alder reaction catalyzed by MOF-808(Zr) or Cu(II)-ATP-MOF-808(Zr) in MES (20 mM, pH 5.5) at 4° C. for 3 h. Cu(OTf)₂: 50 μM; ATP: 250 μM (70% of ATP was adsorbed in MOF-808(Zr)); MOF-808(Zr): 1 mg/mL; aza-chalcone (1): 1 mM (i.e., 5% catalyst loading); cyclopentadiene (2): 16 μL (200 equiv). All data are averaged over three independent experiments.

FIG. 15. Conversion and ee for Michael addition catalyzed by MIL-101(Cr), Cu(II)-MIL-101(Cr), homogeneous catalyst Cu(II)-ATP, heterogenized catalyst Cu(II)-ATP-MIL-101(Cr) or heterogenized catalyst Cu(II)-ATP-MIL-101(Cr)* prepared by an alternative procedure (see experimental section for the procedure details) in MES (20 mM, pH 5.5) at 4° C. for 2 days. Cu(OTf)₂: 50 μM; ATP: 250 μM; MIL-101(Cr): 1 mg/mL; α, β-unsaturated 2-acyl imidazole (4): 1 mM (i.e., 5% catalyst loading); dimethyl malonate (5): 11.4 μL (100 equiv). All data were averaged over three independent experiments.

FIG. 16. Conversion and ee for Michael addition catalyzed by homogeneous catalyst Cu(II)-ATP or heterogenized catalyst Cu(II)-ATP-MIL-101(Cr) in MES (20 mM, pH 5.5) at room temperature for 2 days. Same other reaction conditions as in FIG. 15. All data are averages of three independent experiments.

FIG. 17. Conversion and ee for Michael addition catalyzed by homogeneous catalyst Cu(II)-ATP or heterogenized catalyst Cu(II)-ATP-MIL-101(Cr) in MES (20 mM, pH 5.5) at 4° C. for 2 days. Cu(OTf)₂: 50 μM; ATP: 250 μM; MIL-101(Cr): 1 mg/mL; α,β-unsaturated 2-acyl imidazole (4): 1 mM (i.e., 5% catalyst loading); nitromethane (5a): 53.6 μL (1000 equiv). MIL-101(Cr) exhibits no observable catalytic activity under the condition and time tested in all cases. All data were averaged over three independent experiments.

FIG. 18A. Chemical structures of ATP, other nucleotides and adenosine.

FIG. 18B. Adsorption of ATP or other nucleotides or adenosine in 1 mg MIL-101(Cr) at 4° C. in the presence of MES buffer (200 mM, pH=5.5).

FIG. 18C. Remaining amount of ATP or other nucleotides adsorbed in MIL-101(Cr) after 0-6 washings at 4° C. in the presence of MES buffer (200 mM, pH=5.5).

FIG. 19A. Conversion and ee for Diels—Alder reaction catalyzed by homogeneous catalyst Cu(II)-dATP or heterogenized catalyst Cu(II)-dATP-MIL-101(Cr) in MES (20 mM, pH 5.5) at 4° C. for 3 h. Same reaction conditions as in FIG. 5. All data were averaged over three independent experiments.

FIG. 19B. Conversion and ee for Diels—Alder reaction catalyzed by homogeneous catalyst Cu(II)-dATP or heterogenized catalyst Cu(II)-dATP-MIL-101(Cr) in MES (20 mM, pH 5.5) at 4° C. for 3 h. Same reaction conditions as in FIG. 8. All data were averaged over three independent experiments.

FIG. 19C. Conversion and ee for Diels—Alder reaction catalyzed by homogeneous catalyst Cu(II)-dATP or heterogenized catalyst Cu(II)-dATP-MIL-101(Cr) in MES (20 mM, pH 5.5) at 4° C. for 2 days. Cu(OTf)₂: 50 μM; dATP: 250 μM; MIL-101(Cr): 1 mg/mL; α,β-unsaturated 2-acyl imidazole (4): 1 mM (i.e., 5% catalyst loading); cyclopentadiene (2): 16 μL (200 equiv). All data were averaged over three independent experiments.

FIG. 19D. Conversion and ee for Michael addition catalyzed by homogeneous catalyst Cu(II)-GTP or heterogenized catalyst Cu(II)-ATP-MIL-101(Cr) in MES (20 mM, pH 5.5) at 4° C. for 2 days. Same reaction conditions as in FIG. 15. MIL-101(Cr) exhibits no observable catalytic activity under the condition and time tested in all cases. All data were averaged over three independent experiments.

FIG. 20A. The Michael addition conversion of aza-chalcone (1) in CH₃CN (10 μL of 0.1 M solution) by the addition of dimethyl malonate (5) (11.4 μL, 100 eq.) to form product (8).

FIG. 20B. Conversion and ee for the reaction of FIG. 20A catalyzed by homogeneous catalyst Cu(II)-ATP or heterogenized catalyst Cu(II)-ATP-MIL-101(Cr) wherein the mixture was stirred for 30 min at 4° C. All data were averaged over three independent experiments.

FIG. 20C. Conversion and ee for the reaction of FIG. 20A catalyzed by homogeneous catalyst Cu(II)-ATP or heterogenized catalyst Cu(II)-ATP-MIL-101(Cr) wherein the mixture was stirred for 2 h at 4° C. All data were averaged over three independent experiments.

FIG. 20D. Conversion and ee for the reaction of FIG. 20A catalyzed by homogeneous catalyst Cu(II)-ATP or heterogenized catalyst Cu(II)-ATP-MIL-101(Cr) wherein the mixture was stirred for 6 h at 4° C. All data were averaged over three independent experiments.

FIG. 20E. Conversion and ee for the reaction of FIG. 20A catalyzed by homogeneous catalyst Cu(II)-ATP or heterogenized catalyst Cu(II)-ATP-MIL-101(Cr) wherein the mixture was stirred for 2 days at 4° C. All data were averaged over three independent experiments.

### DETAILED DESCRIPTION

The presently disclosed subject matter now will be described more fully hereinafter with reference to the accompanying Figures, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Therefore, it is to be understood that the presently disclosed subject matter is not to be limited to the specific embodiments disclosed and that modifications and other embodiments are intended to be included within the scope of the appended claims.

For purposes of this disclosure, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Sorrell, Organic Chemistry, 2^{nd} edition, University Science Books, Sausalito, 2006; Smith, March's Advanced Organic Chemistry: Reactions, Mechanism, and Structure, 7 th Edition, John Wiley & Sons, Inc., New York, 2013; Larock, Comprehensive Organic Transformations, 3^{rd} Edition, John Wiley & Sons, Inc., New York, 2018; and Carruthers, Some Modern Methods of Organic Synthesis, 3^{rd} Edition, Cambridge University Press, Cambridge, 1987; the entire contents of each of which are incorporated herein by reference.

“Substantially devoid” is defined herein to mean that none of the indicated substance is intentionally added or present. For example, less than about 1 wt %, preferably less than about 0.1 wt %, and even more preferably less than about 0.01 wt % of the indicated substance is present.

The term “about,” when used in connection with one or more numbers or numerical ranges, should be understood to refer to all such numbers, including all numbers in a range and modifies that range by extending the boundaries slightly above and slightly below the numerical values set forth by, for example, +/−5%. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

The phrase “in one embodiment” or “in some embodiments” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references, i.e., “one or more,” unless the context clearly dictates otherwise. The present disclosure also contemplates other embodiments “comprising,” “consisting of” and “consisting essentially of,” the embodiments or elements presented herein, whether explicitly set forth or not. Likewise, the term “include” and its grammatical variants are intended to be non-limiting, such that recitation of items in a list is not to the exclusion of other like items that can be substituted or added to the listed items.

As used herein, the term “metal—organic frameworks (MOFs)” refers to a class of compounds consisting of metal ions or clusters coordinated to organic ligands, including mono-, di-, tri-, or tetravalent organic ligands. The organic ligands also are referred to as linkers.

As used herein, adsorption “in and/or on” corresponds to the adsorption of the organophosphates on the surface of the MOFs or within the pores of the MOFs.

As defined herein, a “parent MOF” corresponds to an MOF species that has not yet been modified by the intentional adsorption of organophosphates (e.g., nucleotides) thereto, as described herein.

It should be appreciated that the term “adsorption” is intended to comprise physisorption, chemisorption, or both.

As used herein, a “Diels-Alder” reaction refers to the [4+2] cycloaddition of a conjugated diene (in the s-cis conformation) and a dienophile to produce a new six-membered ring having 1 C—C π bond, as understood by the person skilled in the art.

As used herein, a “Michael addition” reaction refers to a nucleophilic 1,4-addition reaction wherein a Michael donor (e.g., an enolate or other nucleophiles such as amines, thiolates, enamines and Gilman reagents) and a Michael acceptor (e.g., an electrophilic alkene such as an unsaturated ketone, nitrile or ester) react to produce a carbon-carbon bond at the acceptor's β-carbon.

As used herein, a “Friedel-Crafts Alkylation” refers to the alkylation of an aromatic ring by treating said aromatic ring with an alkyl halide in the presence of a strong Lewis acid (e.g., AlCl₃).

Broadly, the presently disclosed subject matter provides a method for post-synthetic modification of metal-organic frameworks (MOFs), the method comprising contacting a MOF with organophosphate molecules comprising mono-, di-, tri-, or oligo-phosphate moieties that are attached to nucleobase moieties (e.g., adenine, guanine, cytosine, thymine and similar moieties like their deoxy derivatives). Further, the presently disclosed subject matter relates to the modified MOFs comprising the organo-phosphate molecules that are the product of said method.

In a first aspect, a method for adsorbing at least one organophosphate in and/or on metal-organic frameworks (MOFs) is described, said method comprising:

contacting at least one MOF with an aqueous solution comprising at least one organophosphate for a time and at a temperature that effectuates substantial adsorption of the at least one organophosphate in and/or on the MOFs to produce modified MOFs; and
washing the modified MOFs with water to remove any non-adsorbed organophosphates.

In some embodiments, the first aspect relates to a method for adsorbing at least one nucleotide in and/or on metal-organic frameworks (MOFs), said method comprising:

contacting at least one MOF with an aqueous solution comprising at least one nucleotide for a time and at a temperature that effectuates substantial adsorption of the at least one nucleotide in and/or on the MOFs to produce modified MOFs; and
washing the modified MOFs with water to remove any non-adsorbed nucleotides.

In some embodiments, the first aspect relates to a method for adsorbing at least one organophosphate in and/or on metal-organic frameworks (MOFs), said method comprising:

contacting at least one MOF with an aqueous solution comprising at least one metal ion and at least one organophosphate for a time and at a temperature that effectuates substantial adsorption of the at least one organophosphate and the at least one metal ion in and/or on the MOFs to produce modified MOFs; and
washing the modified MOFs with water to remove any non-adsorbed organophosphates.

In some embodiments, the first aspect relates to a method for adsorbing at least one nucleotide in and/or on metal-organic frameworks (MOFs) is described, said method comprising:

contacting at least one MOF with an aqueous solution comprising at least one metal ion and at least one nucleotide for a time and at a temperature that effectuates substantial adsorption of the at least one nucleotide and the at least one metal ion in and/or on the MOFs to produce modified MOFs; and
washing the modified MOFs with water to remove any non-adsorbed nucleotides.

Advantageously, the adsorption of at least a fraction of the at least one organo-phosphate (e.g., at least one nucleotide) onto the MOFs is irreversible. Further, in some embodiments, the modified MOFs comprise the irreversibly adsorbed organophosphate moieties while substantially retaining the crystallinity of the parent MOF, and while substantially retaining a large fraction of the original porosity of the parent MOF. In some embodiments, the modified MOF further exhibits an enhanced hydrophilicity and water stability compared to the parent MOF.

In some embodiments, the MOF is water stable and comprises MOFs including, but not limited to, MIL-101 and analogues thereof such as MIL-101(Cr) and MIL-101(Fe); MIL-100(Cr); MOF-808(Zr); PCN-333 analogues such as PCN-333(A1), PCN-333(Fe), and PCN-333(Cr); UiO-67 and analogues thereof such as UiO-67(Zr), UiO-67-bpydc(Zr); Ni-BPM (Ni-biphenyl meta); INA@MOF-808(Zr) (isonicotinic acid grafted MOF-808); Ni-IRMOF-74-IV; ZIF-67(Zr); UiO-66 and analogues thereof; NU-1000 and analogues thereof; HKUST-1(Cu); and PCN-222 analogues such as PCN-222(H), PCN-222(Fe) and PCN-222(Co). In some embodiments, the MOF comprises a MIL-101 analogue. In some embodiments, the MOF comprises MIL-101. In some embodiments, the MOF comprises MIL-101(Cr).

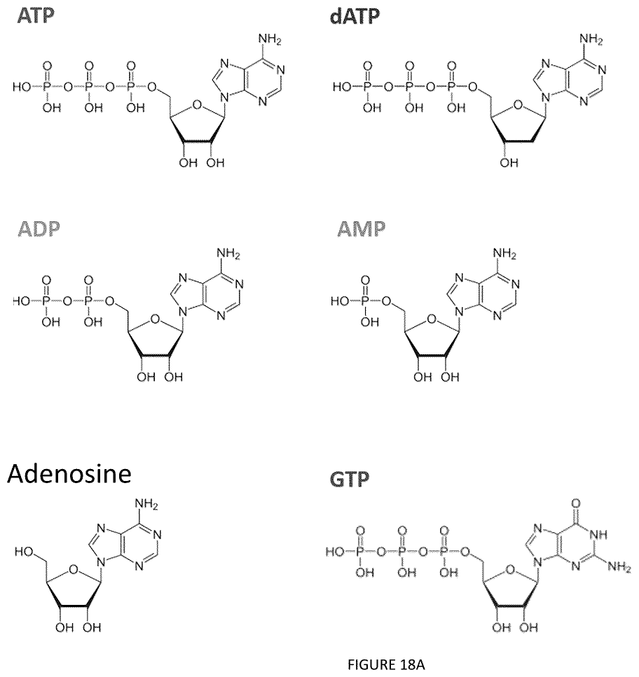

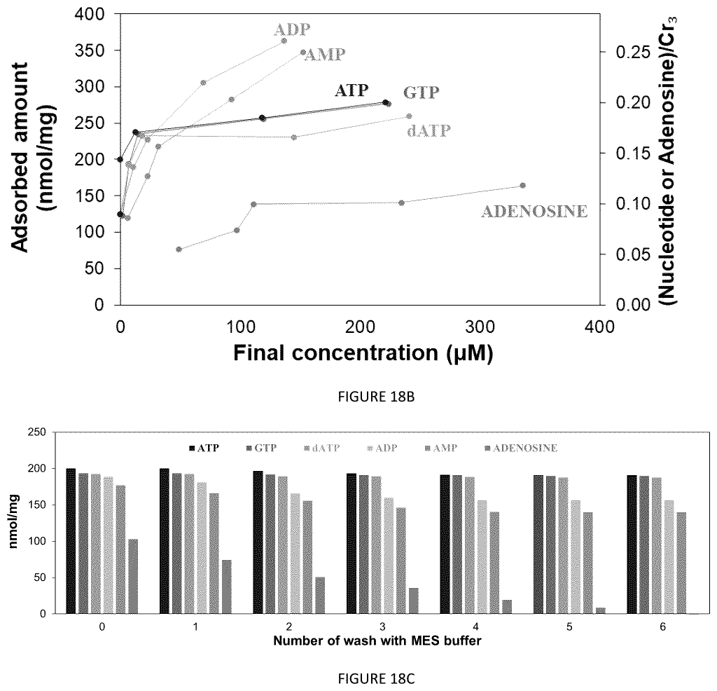

In some embodiments, the at least one organophosphate includes, but is not limited to, nucleotides including, but not limited to, ATP, ADP, AMP, dATP, GTP, their analogues, and combinations thereof (see FIG. 18A). In some embodiments, the MOF is selected by its ability to irreversibly adsorb organophosphates (e.g., nucleotides) while not irreversibly adsorbing adenosine.

In some embodiments, the ratio of organophosphate (e.g., nucleotide) per metal site in the MOF is in a range from about 0.09:1 to about 0.59:1 for irreversibly adsorbed organophosphates. In some other embodiments, the ratio of organophosphate (e.g., nucleotide) per metal site in the MOF is in a range from about 0.1:1 to about 1.2:1 for the cumulative total of irreversibly adsorbed organophosphates plus the organophosphates that adsorbed but can be washed off by repeated washings.

In some embodiments, the metal site comprises a Cr₃ cluster and the ratio of organophosphate (e.g., nucleotide) per Cr₃ cluster of the MOF is in a range from about 0.09:1 to about 0.59:1 for irreversibly adsorbed organophosphates. In some embodiments, the metal site comprises a Cr₃ cluster and the ratio of organophosphate (e.g., nucleotide) per Cr₃ cluster of the MOF is in a range from about 0.1:1 to about 0.2:1 for irreversibly adsorbed organophosphates. In some embodiments, the metal site comprises a Cr₃ cluster and the ratio of organophosphate (e.g., nucleotide) per Cr₃ cluster of the MOF is in a range from about 0.2:1 to about 0.3:1 for irreversibly adsorbed organophosphates. In some embodiments, the metal site comprises a Cr₃ cluster and the ratio of organophosphate (e.g., nucleotide) per Cr₃ cluster of the MOF is in a range from about 0.3:1 to about 0.4:1 for irreversibly adsorbed organophosphates. In some embodiments, the metal site comprises a Cr₃ cluster and the ratio of organophosphate (e.g., nucleotide) per Cr₃ cluster of the MOF is in a range from about 0.4:1 to about 0.5:1 for irreversibly adsorbed organophosphates. In some embodiments, the metal site comprises a Cr₃ cluster and the ratio of organophosphate (e.g., nucleotide) per Cr₃ cluster of the MOF is in a range from about 0.5:1 to about 0.59:1 for irreversibly adsorbed organophosphates. In some other embodiments, the metal site comprises a Cr₃ cluster and the ratio of organophosphate (e.g., nucleotide) per Cr₃ cluster of the MOF is in a range from about 0.1:1 to about 1.2:1 for the cumulative total of irreversibly adsorbed organophosphates plus the organophosphates that adsorbed but can be washed off by repeated washings. In some embodiments, the MOF is MIL-101(Cr) and the irreversibly adsorbed nucleotide to Cr₃ ratio is in the range of 0.09 to 0.59.

In some embodiments, the at least one metal ion comprises copper (II) ions, zinc (II) ions, cobalt (II) ions, nickel (II) ions, and magnesium ions. In some embodiments, the at least one metal ion comprises copper (II) ions. In some embodiments, the metal ion-containing salt comprises a nitrate anion or a trifluoromethanesulfonic acid ((OTf)₂) anion. When present, the molar ratio of metal ions to organophosphates (e.g., nucleotides) is in a range from about 0.1 to about 0.3, or about 0.15 to about 0.25, or about 0.18 to about 0.22. In some embodiments, the adsorbed metal ions associate with the organophosphates (e.g., nucleotides).

In some embodiments, the aqueous solution comprising at least one organophosphate (e.g., nucleotide) further comprises a buffer including, but not limited to, MES (2-(N-morpholino)ethanesulfonic acid) buffer or a phosphate buffer. In some embodiments, the buffer is adjusted with a hydroxide base to an effective pH. In some embodiments, the effective pH is about 5 to about 7. In some embodiments, the effective pH is about 5 to about 6. In some embodiments, the effective pH is about 6 to about 7.

In some embodiments, the aqueous solution comprising at least one organophosphate (e.g., nucleotide) and at least one metal ion further comprises a buffer including, but not limited to, MES (2-(N-morpholino)ethanesulfonic acid) buffer.

In some embodiments, the time and temperature to effectuate substantial adsorption of the at least one organophosphate (e.g., nucleotide) in and/or on the MOFs to produce a modified MOF includes time in a range from about 1 h to about 24 h and temperature in a range from about 1° C. to about 20° C. In some embodiments, the time is in a range from about 1 h to about 5 h, or about 5 h to about 10 h, or about 10 h to about 14 h, or about 11 h to about 13 h, or about 14 h to about 19 h, or about 19 h to about 24 h. In some embodiments, the temperature is in a range from about 1° C. to about 10° C., or about 1° C. to about 5° C., or about 2° C. to about 5° C., or about 3° C. to about 5° C.

In a second aspect, a modified MOF material is described, wherein the modified MOF material comprises at least one MOF and irreversibly adsorbed organophosphates.

In some embodiments of the second aspect, the modified MOF material comprises at least one MOF and irreversibly adsorbed nucleotides.

In some embodiments of the second aspect, the modified MOF further comprises metal ions, wherein the metal ions are adsorbed in and/or on the modified MOF.

In some embodiments, the modified MOF material of the second aspect is produced using the method of the first aspect described herein.

In some embodiments of the second aspect, the location of irreversibly adsorbed organophosphates (e.g., nucleotides) is in the proximity of Cr₃ clusters.

It was surprisingly discovered that in the presence of metal ions (e.g., Cu(II) ions), the modified MOFs described herein can function as stable and reusable enantioselective heterogeneous catalysts for reactions like Diels-Alder and Michael additions. Compared to the corresponding homogeneous nucleotide-based artificial metalloenzymes (ArMs), the modified MOFs, also referred to as MOF-supported nucleotide-based ArMs, exhibit significantly enhanced activity and selectivity in certain cases, demonstrating their potential as a new class of enantioselective heterogeneous catalysts.

Accordingly, in a third aspect, the modified MOF material made using the method of the first aspect is used as a catalyst for enantio-selective reactions. For example, the modified MOF further modified by the presence of metal ions exhibits enantioselectivity for reactions including, but not limited to, Diels Alder, Michael Addition, and Friedel-Crafts Alkylation. In some embodiments, the metal ions (e.g., Cu(II)) associate with the adsorbed organophosphates (e.g., nucleotides) such that an enantioenriched product is produced.

In some embodiments, the modified MOF material of the second aspect is used as a catalyst for enantio-selective reactions. For example, the modified MOF further modified by the presence of metal ions exhibits enantioselectivity for reactions like Diels Alder, Michael Addition, and Friedel-Crafts Alkylation.

In a fourth aspect, the modified MOF material made using the method of the first aspect is used as an adsorbent material. In some embodiments, the modified MOF material is used to adsorb water. In some embodiments, the modified MOF material is used to selectively adsorb copper ions. In some other embodiments, the modified MOF material is used to adsorb chiral molecules for enantioselective separations.

In some embodiments, the modified MOF material of the second aspect is used as an adsorbent material. In some embodiments, the modified MOF material is used to adsorb water. In some embodiments, the modified MOF material is used to selectively adsorb copper ions. In some other embodiments, the modified MOF material is used to adsorb chiral molecules for enantioselective separations.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter. The synthetic descriptions and specific examples that follow are only intended for the purposes of illustration and are not to be construed as limiting in any manner to make compounds of the disclosure by other methods.

### Example 1

### 1.1. Methods and Materials

Chromium (III) nitrate nonahydrate, hydrofluoric acid, deoxyadenosine triphosphate, disodium salt (dATP) and salmon testes DNA were purchased from Sigma-Aldrich. Terephthalic acid (1,4-benzendicarboxylate) was purchased from Acros Organics. Adenosine triphosphate, disodium salt (ATP) was purchased from EMD Millipore. 2-(N-morpholino)ethanesulfonic acid (MES) and adenosine monophosphate (AMP) were purchased from RPI. Adenosine diphosphate (ADP) was purchased from MP biomedicals. Guanosine triphosphate, disodium salt (GTP) and adenosine were purchased from Chem-Impex International. Copper (II) trifluoromethanesulfonate was purchased from TCI. All purchased chemicals were used without further purification except where otherwise noted. Ultrapure water (18.2 MΩ) was obtained from a Millipore® Simplicity® water system.

MIL-101(Cr) was synthesized following a reported protocol [2]. Cr(NO₃)₃·9H₂O (1 mmol), 1,4-benzendicarboxylate (BDC) (1 mmol), HF (1 mmol) and ultrapure water (265 mmol) were mixed by stirring for 0.5 h. Then the mixture was transferred to an autoclave and hydrothermally treated for 8 h at 220° C. After the hydrothermal treatment, the product was first washed by DMF (150 mL DMF/g MIL-101(Cr)) three times and then washed by ethanol (150 mL ethanol/g MIL-101(Cr)) three times. The purified product was first dried by airflow and then activated by heating under vacuum at 120° C. for 12 h.

### 1.2. ATP Adsorption and Desorption in Water

An aqueous solution of ATP (500 μL, 250 μM/500 μM/1000 μM/2000 μM/3000 μM/4000 μM/5000 μM) was first prepared. To this solution, a suspension of MIL-101(Cr) (500 μL, 2 mg/mL) was added. The mixture (125 μM/250 μM /500 μM /1000 μM /1500 μM /2000 μM /2500 μM of ATP and 1 mg/mL MIL-101(Cr)) was stirred with a stir bar at 1000 rpm for 12 h at 4° C. The suspension was then centrifuged. UV absorption at 260 nm was measured for the supernatant. The final concentration of ATP that remained in water was calculated by Equation 1 and the molar amount of ATP adsorbed in MIL-101(Cr) was calculated by Equation 2:

final concentration (μM)=Abs₂₆₀(supernatant)/Abs₂₆₀(initial solution)×initial concentraion (μM) (1)

nmol adsorbed/mg MIL−101(Cr)=(initial concentration−final concentration)×V÷M (2)

where V is the total volume of the ATP solution and M is the mass of MIL-101(Cr). It was assumed that there was no volume change of the solution upon ATP adsorption.

With different initial ATP concentrations, the final ATP concentrations and the moles of ATP adsorbed in MIL-101(Cr) were calculated.

The supernatant of the ATP adsorption solution with an initial ATP concentration of 500 μM was removed and fresh ultrapure water (1 mL) was added to the precipitate. The new mixture was stirred with a stir bar at 1000 rpm for 12 h at 4° C. The new suspension was then centrifuged. UV absorption at 260 nm was measured for the new supernatant. The desorbed concentration of ATP and the remaining molar amount of ATP adsorbed in MIL-101(Cr) was calculated by Equation 3 and Equation 4, respectively:

desorbed concentration (μM)=Abs₂₆₀(new supernatant)/Abs₂₆₀(1 μM ATP) (3)

nmol adsorbed/mg MIL−101(Cr)=nmol adsorbed/mg MIL−101(Cr) before the wash−desorbed concentration×V÷M (4)

where V is the total volume of the ATP solution and M is the mass of MIL-101(Cr).

The second and third washes were performed using the same protocol and the remaining molar amount of ATP adsorbed in MIL-101(Cr) after each wash was calculated.

### 1.3. ATP Adsorption and Desorption in MES Buffer

Aqueous solutions of ATP (25 μL/40 μL/50 μL/75 μL/100 μL, 5 mM), Cu(OTf)₂ (25 μL/40 μL/50 μL/75 μL/100 μL, 1 mM), MES buffer (100 μL, 200 mM) and 350 μL/320 μL/300 μL/250 μL/200 μL ultrapure water were first mixed. The solution was stirred with a stir bar at 1000 rpm for 0.5 h at 4° C. Then a suspension of MIL-101(Cr) (500 μL, 2 mg/mL) was added. The mixture of ATP (125 μM/200 μM/250 μM/375 μM/500 μM), Cu(OTf)₂ (25 μM/40 μM/50 μM/75 μM/100 μM) and 1 mg/mL MIL-101(Cr)) in MES buffer (20 mM, pH=5.5) was stirred at 1000 rpm for 12 h at 4° C. The suspension was then centrifuged. UV absorption at 260 nm was measured for the supernatant. The final concentration of ATP remaining in the MES buffer was calculated by Equation 1 and the molar amount of ATP adsorbed in MIL-101(Cr) was calculated by Equation 2.

With different initial ATP concentrations, the final ATP concentration and the molar amount of ATP adsorbed in MIL-101(Cr) were calculated.

The supernatant of the ATP adsorption solution (in MES buffer) with an initial ATP concentration of 200 μM was then removed and fresh MES buffer (1 mL, 20 mM, pH=5.5) was added to the precipitate. The new mixture was stirred with a stir bar at 1000 rpm for 12 h at 4° C. The new suspension was then centrifuged. UV absorption at 260 nm was measured for the new supernatant. The desorbed concentration of ATP and the remaining molar amount of ATP adsorbed in MIL-101(Cr) was calculated by Equation 3 and Equation 4, respectively.

The 2nd to the 6th wash were performed using the same protocol and the remaining molar amount of ATP adsorbed in MIL-101(Cr) after each wash was calculated.

### 1.4. Synchrotron X-ray Diffraction

Synchrotron X-ray powder diffraction (SXPD) was conducted at Beamline 17-BM at the Advanced Photon Source (APS) at the Argonne National Laboratory (ANL). MIL-101(Cr) and ATP-MIL-101(Cr) with a loading of 0.19 ATP/Cr₃ were loaded into a 1.1 mm diameter open ended fused silica capillary, packed with silica wool at both ends. The loaded capillary was then connected to a flow cell setup [14]. An Oxford Cryostream device was used for temperature control. During the experiment, the samples were under a constant flow of helium at 10 cc/min. For each sample, the temperature was raised to 373 K and held for 10 min to remove volatile solvent in the framework, if there was any. Two-dimensional diffraction data were collected throughout the thermal activation process, using a monochromatic X-ray of 0.45119 Å. The data collection was through the program QXRD and a VAREX XRD 4343CT flat panel detector placed in the X-ray transmission geometry. The raw two-dimensional data were converted to conventional 1D powder diffraction patterns with the program GSAS-II [15]. Rietveld analysis of the 1D patterns was performed with TOPAS version 5 [16]. Structure factor information obtained through the Rietveld analysis was used to calculate the difference electron density maps with the VESTA software [17].

To calculate the map, a model structure without any solvent was built based on a previous published MIL-101(Cr) structure [18]. The structure model was fit to the XRD data, with only a few parameters refined, including one lattice constant (a-axis length), one sample displacement parameter, two atomic displacement parameters (ADPs), one for Cr and the other for all the non-Cr atoms, as well as a four-term Chebyshev function to fit the background. It was obvious that the model, which has empty pores, fits better to the pattern of the MIL-101(Cr) than to the ATP-MIL-101(Cr). The difference electron density map for the ATP-MIL-101(Cr) was generated based on the first 50 low angle reflections with a cut-off 2θ of 3.26°, corresponding to a minimum d-space of 7.96 Å. Mid to high angle peaks were excluded from the map calculation because their intensities mainly reflect the framework atom positions and are nearly not affected by the diffuse electron density of the ATP molecules. The principle here is the same as the difference envelope density (DED) method that is commonly used to analyse guest molecules in MOFs.

### 1.5. DFT Studies

A MIL-101(Cr) unit cell was obtained from the CoREMOF 2019 database [19]. Cluster models were cleaved from the bulk unit cell and terminated with formate linkers. To retain the crystallographic face of the node super-tetrahedron, the hydrogen on each terminal formate linker was fixed in space. Starting structures for the nucleotide bases were obtained from the PubChem database maintained at the National Institutes of Health (NIH).

A multistep procedure was used to obtain optimized structures considering the size of the nucleotide molecules. Furthermore, each nucleotide has many residues that afford dative interactions that complicate the potential energy surface (PES) and thus the adsorption configurations have a significant (in many cases much greater than 10 kJ/mol) influence on the adsorption energy. The choice for global optimization scheme was to perform molecular dynamics at an elevated temperature using the semi-empirical Extended Tight-binding (xTB) package [20] by Grimme in order to obtain an ensemble of plausible adsorption configurations. We used the GFN2-xTB [21] method which includes thigh-binding, multipole electrostatics, and density-dependent dispersion contributions as a pre-optimization to generate candidate adsorption sites for more accurate calculations. For both gas phase nucleotides and adsorbed nucleotides, we performed 5 ps of MD at 500 K using xTB with a timestep of 4 fs, a 4× greater hydrogen mass, and all X-H bonds were constrained. The elevated temperature was sufficient to cleave dispersion interactions and explore different adsorption configurations. We then quenched 10 snapshots (images) from the MD trajectory based on their potential energy. Each image was required to be at least 24 fs apart to sample different regions of the trajectory. These images were then optimized to their ground state using GFN2-xTB. The optimized images were then visually inspected, and their energies were compared to establish a subset of images for further optimization.

DFT optimizations were performed using ORCA 4.2.1 [22, 23] using 3 levels of theory. First, the GFN2-xTB structures were optimized using the BP86 functional with a def2-TZVP basis on Cr atoms, and a def2-SVP basis set for all other atom-types with the def2/J auxiliary basis [24, 25]. Next, the same basis set was used but the M06-L functional was employed for the next optimization. We then performed single point calculations with the M06-2X functional. All calculations were dispersion-corrected using the D3 approach by Grimme [26]. Spin states for Cr in the MIL-101(Cr) nodes were taken as the stable spin configurations determined by Barona and Snurr [27].

### 1.6. ³¹P MAS NMR Spectrum of ATP-MIL-101(Cr)

Solid-state ³¹P NMR experiments were performed on a Bruker AVANCE NMR spectrometer at 11.7 T in a wide-bore superconducting magnet, corresponding to a ³¹P resonant frequency of approximately 202.5 MHz. MIL-101(Cr) samples were saturated with ATP at a loading of approximately 0.3 ATP/Cr₃ and packed in 1.3 mm magic-angle spinning (MAS) rotors. Spin-echo ³¹P NMR experiments were conducted at a MAS frequency of 50 kHz under ambient temperature and pressure conditions. The spin-echo experiment used rotor-synchronized delays corresponding to one rotor period, and all ³¹P pulses were set at a nutation frequency of 62.5 kHz. For MIL-101(Cr) with adsorbed ATP, ³¹P spin-echo NMR spectra were acquired using a short recycle delay of 50 ms, due to the rapid spin-lattice relaxation of ³¹P species in proximity to paramagnetic Cr(III) moieties in the MIL-101(Cr) framework, and 66560 scans were recorded. For crystalline ATP, ³¹P spin-echo NMR spectra were acquired with a recycle delay of 200 s, and 8 scans were recorded. ³¹P T₁ measurements were performed using a saturation recovery experiment with echo detection and delay times ranging from 100 μs to 80 ms. The ³¹P chemical shifts were indirectly referenced to a solution of 85% phosphoric acid. Lineshape analyses and deconvolutions were performed using DMfit software [28].

### 1.7. Nitrogen Adsorption

Nitrogen adsorption isotherms at 77 K were measured using an Anton Paar Autosorb iQ-XR instrument equipped with a CryoSync Accessory. Prior to isotherm measurement, samples were heated under dynamic vacuum from room temperature to 150° C.

### 1.8. Water Vapor Adsorption/Desorption

Water vapor adsorption/desorption isotherms were carried out using a vapor adsorption analyzer (Vstar, Quantachrome) at 25° C. Before testing, samples were degassed at 25° C. under vacuum for one day.

### 1.9. Diels-Alder Reaction in MES Buffer

For the homogeneous catalyst Cu(II)-ATP, aqueous solutions of ATP (50 μL, 5 mM), Cu(OTf)₂ (50 μL, 1 mM), MES buffer (100 μL, 200 mM, pH=5.5, pH adjusted by NaOH) and 800 μL ultrapure water were first mixed. The solution was stirred with a stir bar at 1000 rpm for 0.5 h at 4° C. before starting the reaction as described below.

For the heterogeneous catalyst Cu(II)-ATP-MIL-101(Cr), aqueous solutions of ATP (50 μL, 5 mM), Cu(OTf)₂ (50 μL, 1 mM), MES buffer (100 μL, 200 mM, pH=5.5, pH adjusted by NaOH) and 300 μL ultrapure water were first mixed. The solution was stirred with a stir bar at 1000 rpm for 0.5 h at 4° C. Then a suspension of MIL-101(Cr) (500 μL, 2 mg/mL) was added. The mixture of ATP (250 μM), Cu(OTf)₂ (50 μM) and 1 mg/mL MIL-101(Cr) in MES buffer (20 mM, pH=5.5) was stirred at 1000 rpm for 12 h at 4° C. The suspension was then centrifuged and the supernatant was removed. Fresh MES buffer (1 mL, 20 mM, pH=5.5) was added to the precipitate.

An alternative method (denoted by a *) was used to examine the role of the assembly of the catalyst components before reaction: aqueous solutions of ATP (50 μL, 5 mM), MES buffer (100 μL, 200 mM, pH=5.5, pH adjusted by NaOH), a suspension of MIL-101(Cr) (500 μL, 2 mg/mL) and 300 μL ultrapure water were mixed, followed immediately by the addition of an aqueous solution of Cu(OTf)₂ (50 μL, 1 mM). The mixture of ATP (250 μM), Cu(OTf)₂ (50 μM) and 1 mg/mL MIL-101(Cr) in MES buffer (20 mM, pH=5.5) was stirred at 1000 rpm for 12 h at 4° C.

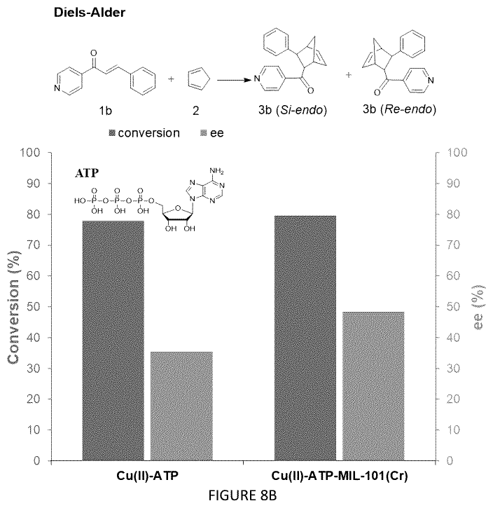

Aza-chalcone (e.g., molecule 1 in FIG. 5) in CH₃CN (10 μL of 0.1 M solution) or NO₂-modified aza-chalcone (e.g., molecule 1a in FIG. 8A) in CH₃CN (10 μL of 0.1 M solution) or (2E)-3-Phenyl-1-(pyridin-4-yl)prop-2-en-1-one (e.g., molecule 1b in FIG. 8B) or a,(3-unsaturated 2-acyl imidazole (4) in CH₃CN (10 μL of 0.1 M solution) was then added. The reaction was initiated by the addition of freshly distilled cyclopentadiene (2) (16 μL, 200 eq.) and the mixture was stirred at 4° C. for 3 h for the reaction between (1) and (2), (1a) and (2), and (1b) and (2), or 2 days for the reaction between (4) and (2). For the reaction catalyzed by the homogeneous catalyst Cu(II)-ATP, after the reaction, the whole solution was extracted with diethyl ether (3 times, 3 mL diethyl ether per time) and then filtrated through a short pad of silica gel. For the reaction catalyzed by the heterogeneous catalyst Cu(II)-ATP-MIL-101(Cr), after the reaction, the suspension was centrifuged. The supernatant was extracted with diethyl ether (3 times, 3 mL diethyl ether per time). The precipitate was washed with 1 mL diethyl ether thoroughly, which was combined to the diethyl ether solution after the extraction of the supernatant. The combined diethyl ether solution was then filtrated through a short pad of silica gel. The solvent was removed under reduced pressure.

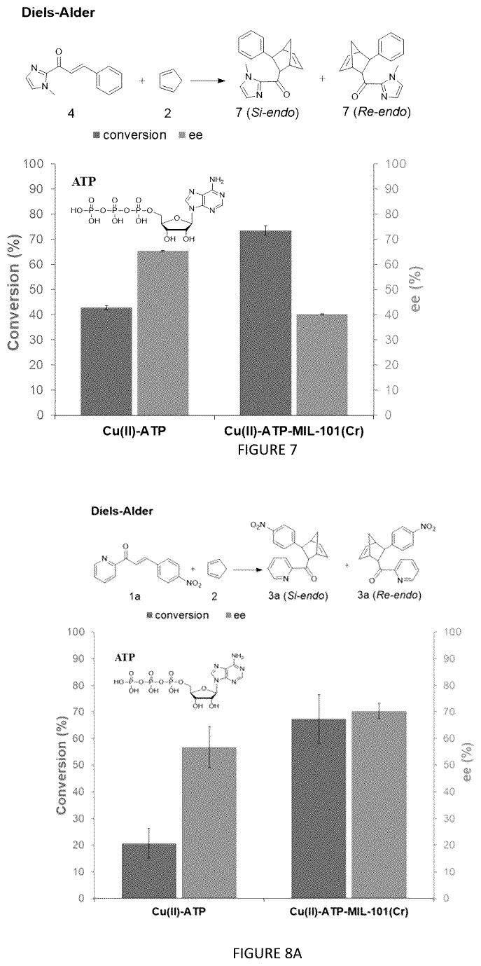

The conversion, diastereoselectivity (endo:exo) and enantiomeric excess (ee) were determined by chiral HPLC (HPLC condition: Product 3 (e.g., in FIG. 5): Daicel chiralcel OD-H, hexane/i-PrOH 98:2, 0.5 mL/min, 212 nm. Retention times: 11.5 (Si-exo), 12.8 min (Re-exo); 14.5 (Re-endo), 18.5 min (Si-endo). Product 3a (e.g., in FIG. 8A): Daicel chiralcel OD-H, hexane/i-PrOH 90:10, 0.5 mL/min, 254 nm. Retention times: 16.7 (Re-exo), 17.6 min (Si-exo); 20.3 (Si-endo), 25.6 min (Re-endo). Product 3b (e.g., in FIG. 8B): Daicel chiralcel OD-H, hexane/i-PrOH 98:2, 0.5 mL/min, 212 nm. Retention times: 30.2 (Si-exo), 38.3 min (Re-exo); 40.6 (Re-endo), 47.3 min (Si-endo). Product 7 (e.g., in FIG. 7): Daicel chiralcel OD-H, heptane/i-PrOH 99:1, 1 mL/min, 254 nm. Retention times: 7.1 (Si-exo), 8.2 min (Re-exo); 9.5 (Re-endo), 13.0 min (Si-endo)). See examples of HPLC trace in SI. ee of all Diels-Alder reactions was calculated by Equation 5:

ee=(moles of Si-endo−moles of Re-endo)/(moles of Si-endo+moles of Re-endo)×100% (5)

### 1.10. Recycling Study for Diels-Alder Reaction in MES Buffer

The reaction was performed as described above. After the reaction the Cu(II)-ATP-MIL-101(Cr) precipitate was washed twice with MES buffer (1 mL, 20 mM, pH=5.5) and then used for the next catalytic cycle in MES buffer (1 mL, 20 mM, pH=5.5) after the addition of azachalcone (1) in CH₃CN (10 μL of 0.1 M solution) and cyclopentadiene (2) (16 μL, 200 eq.). The conversion, diastereoselectivity (endo:exo) and ee were determined by chiral HPLC.

### 1.11. Diels-Alder Reaction in Methanol

For the catalyst Cu(II)-ATP, ATP (250 nmol) and Cu(OTf)₂ (50 nmol) were added to 1 mL methanol. The suspension was stirred with a stir bar at 1000 rpm for 0.5 h at 4° C.

For the heterogeneous catalyst Cu(II)-ATP-MIL-101(Cr), after the preparation of Cu(II)-ATP-MIL-101(Cr) in MES buffer as described above, the Cu(II)-ATP-MIL-101(Cr) precipitate was washed with 1 mL methanol 3 times. 1 mL fresh methanol was then added to the precipitate. A suspension of Cu(II)-ATP-MIL-101(Cr) in methanol was prepared.

Aza-chalcone (1) in CH₃CN (10 μL of 0.1 M solution) was then added. The reaction was initiated by the addition of freshly distilled cyclopentadiene (2) (16 μL, 200 eq.) and the mixture was stirred for 2 days at 4° C. The conversion, diastereoselectivity (endo:exo) and ee were determined by chiral HPLC.

### 1.12. Michael Addition Reaction in MES Buffer

The homogeneous catalyst Cu(II)-ATP and the heterogeneous catalyst Cu(II)-ATP-MIL-101(Cr) were prepared as described above. In a first set of experiments, α, β-unsaturated 2-acyl imidazole (4) in CH₃CN (10 μL of 0.1 M solution) was then added. The reaction was initiated by the addition of dimethyl malonate (5) (11.4 μL, 100 eq.) or nitromethane (5a) (53.6 μL, 1000 eq.) and the mixture was stirred for 2 days or 4 days at 4° C. The conversion and ee were determined by chiral HPLC (HPLC condition: Product 6 (e.g., in FIG. 15): Daicel chiralcel OD-H, heptane/i-PrOH 90:10, 0.5 mL/min, 254 nm. Retention times: 55.6 (R enantiomer), 44.5 min (S enantiomer)). Product 6a (e.g., in FIG. 17): Daicel chiralcel OD-H, heptane/i-PrOH 90:10, 0.5 mL/min, 254 nm. Retention times: 55.8 (R enantiomer), 63.8 min (S enantiomer)). See examples of HPLC trace in SI. ee of the Michael addition reaction between (4) and (5) was calculated by Equation 6, while ee of the Michael addition reaction between (4) and (5a) was calculated by Equation 7:

−ee=(moles of R enantiomer−moles of S enantiomer)/(moles of R enantiomer+moles of S enantiomer)×100% (6)

−ee=(moles of S enantiomer−moles of R enantiomer)/(moles of S enantiomer+moles of R enantiomer)×100% (7)

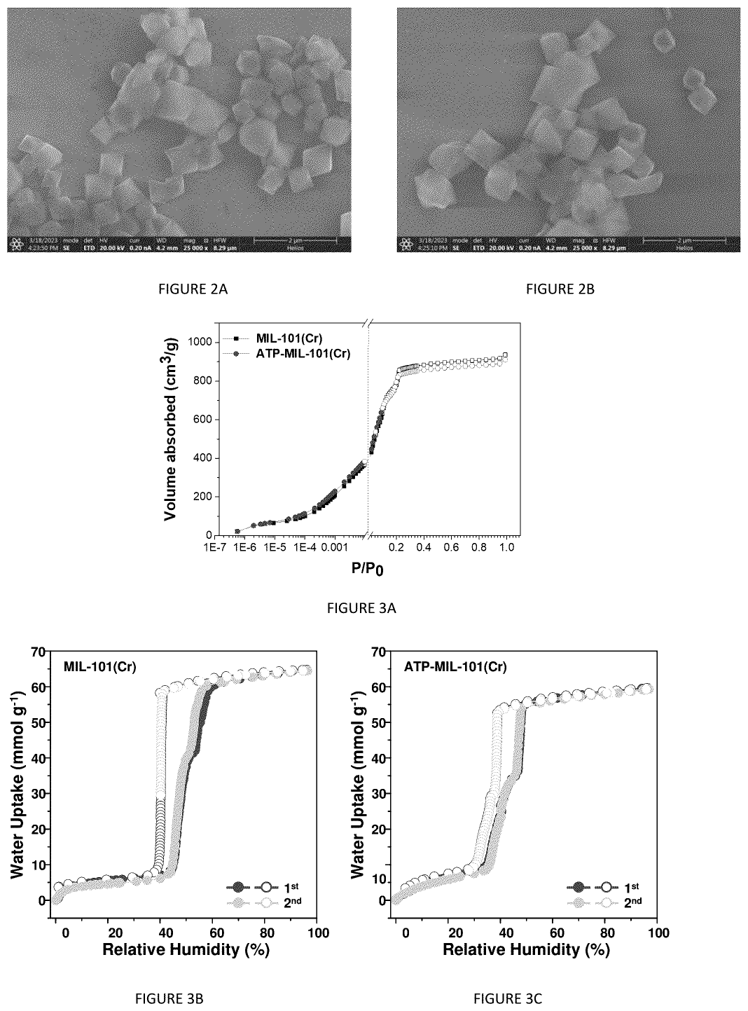

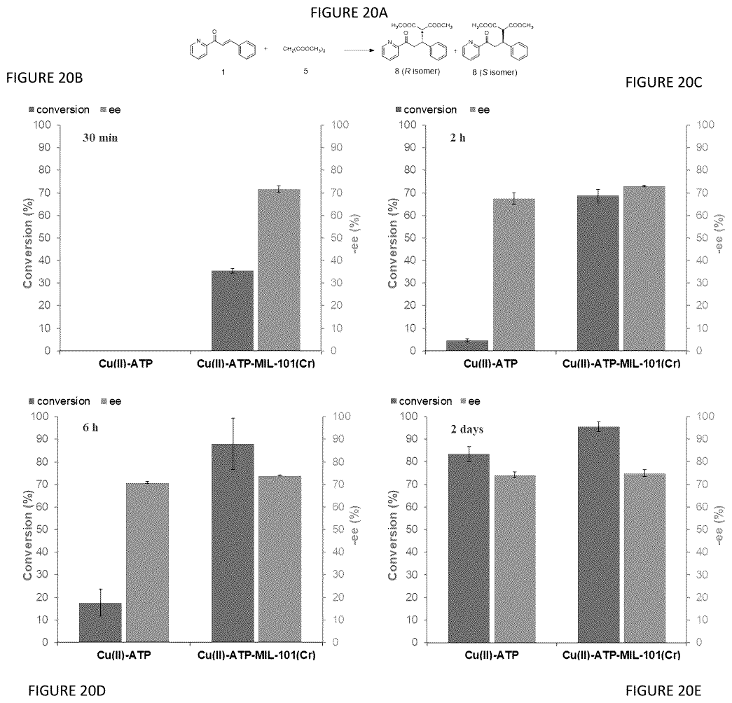

In a second set of experiments, aza-chalcone (1) in CH₃CN (10 μL of 0.1 M solution) was then added. The reaction was initiated by the addition of dimethyl malonate (5) (11.4 μL, 100 eq.) and the mixture was stirred for 30 min (FIG. 20B), 2 h (FIG. 20C), 6 h (FIG. 20D) or 2 days (FIG. 20E) at 4° C. The conversion and ee were determined by chiral HPLC (HPLC condition: Product 8 (e.g., in FIG. 20A): Daicel chiralcel OD-H, hexane/i-PrOH 98:2, 0.5 mL/min, 212 nm. Retention times: 64.3 (S enantiomer), 70.5 min (R enantiomer)).

### 1.13. Other Nucleotides and Adenosine

The adsorption and catalysis experiments relating to other nucleotides and adenosine were exactly the same as described above except for using the corresponding nucleotides or adenosine instead of ATP.

### 1.14. EDS and SEM Measurements

The SEM images and EDS data were collected using a Thermo Fisher Helios G4 UC Focused Ion Dual Beam microscope operating at 10 kV acceleration voltage and 0.4 nA probe current.

1.15. XPS Measurements

X-ray photoelectron spectroscopy (XPS) data were obtained using a PHI 5600 instrument equipped with a Mg Kα flood source (1253.6 eV) and a hemispherical energy analyzer. Scans were taken at a source power of 300 W, with a pass energy of 187.85 eV, 5 sweeps, and 1.6 eV/step. Spectra were analyzed using CASA XPS software.

1.16. DRIFTS Measurements

Fourier transform infrared spectra (FTIR) were collected using diffuse reflectance (DRIFTS) mode with a Nicolet iS50 spectrometer (Thermo Scientific, Waltham, MA). The samples were dried at 100° C. for 24 hours before the measurements and mixed with KBr.

### 2. Results and Discussion

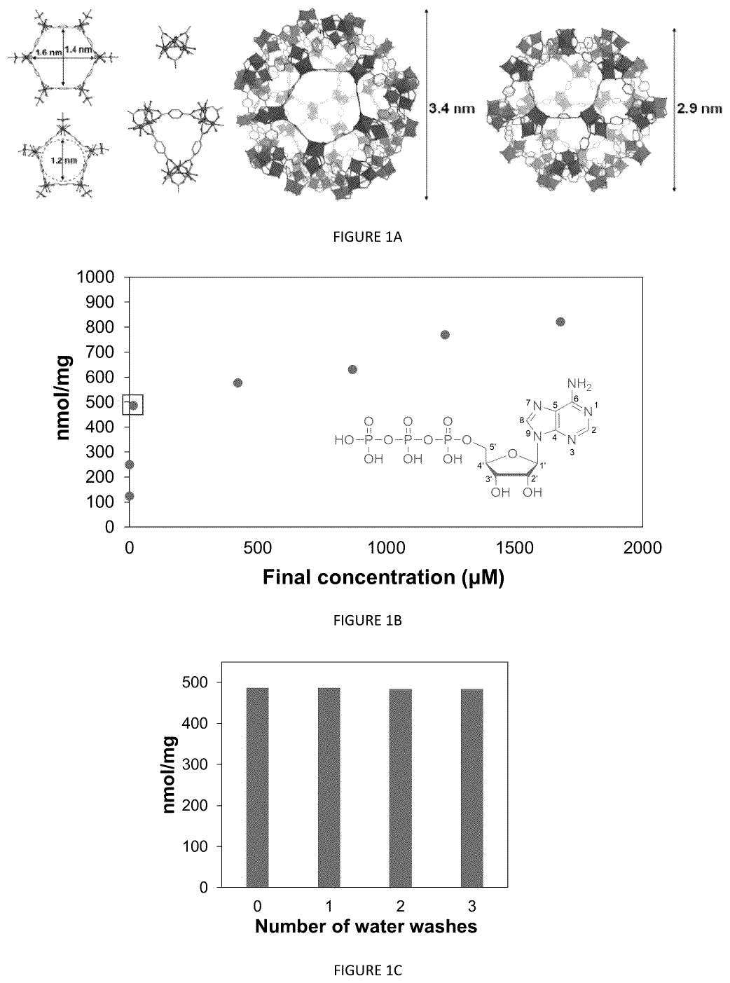

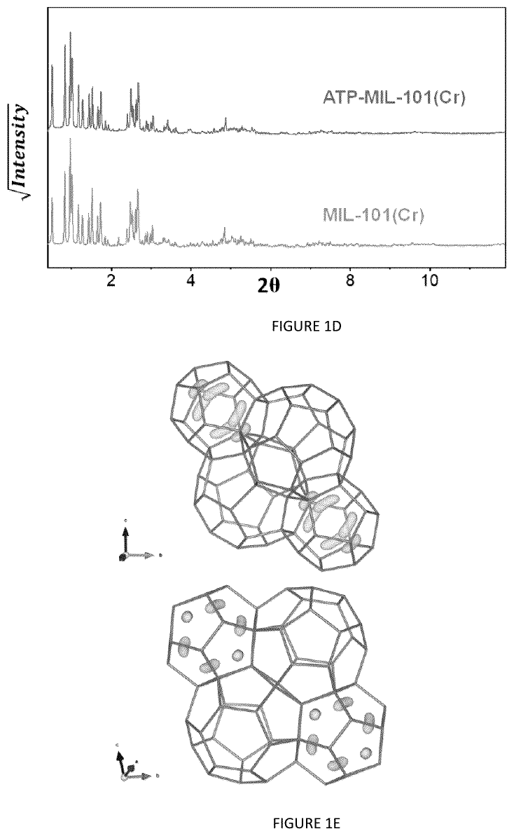

It was found that ATP can irreversibly adsorb in certain MOFs including MIL-101(Cr). FIG. 1B shows the specific amount (in nmol per mg) of ATP adsorbed in MIL-101(Cr) versus the ATP concentration in water, wherein the reported ATP concentration is the final, remaining, concentration in the solution after the adsorbed amount ceases to increase with time. Up to ca. 480 nmol ATP/mg MOF can be irreversibly adsorbed, i.e., ATP molecules are not removed upon repeated washings with water at 4° C. (FIG. 1C). ICP analysis of the ATP-MIL-101(Cr) confirmed this adsorbed amount, which corresponds to 0.325 ATP molecules per Cr₃ cluster. Higher ATP loadings can be accomplished using higher ATP concentrations in water, however, the ATP adsorbed beyond ca. 0.33 ATP/Cr₃ is not irreversibly adsorbed and can be removed by washing with water.

Synchrotron X-ray diffraction (XRD) of MIL-101(Cr) and ATP-MIL-101(Cr) was performed (FIG. 1D) to assess the possible locations of the irreversibly adsorbed ATP. The specific ATP-MIL-101(Cr) sample used for these XRD studies had ATP to Cr₃ cluster ratio of 0.18 (close to that of the ATP-MIL-101(Cr) used for the catalysis experiments that are described below). The XRD results confirmed that both samples are consistent with the MIL-101(Cr) framework with a small difference in lattice constants. Moreover, it is evident that the relative intensities of the major peaks at the low 2θ angles are different between MIL-101(Cr) and ATP-MIL-101(Cr), which is a result of the presence of ATP in ATP-MIL-101(Cr) (FIG. 1D). The electron density map of ATP-MIL-101(Cr) shows that the likely location of irreversibly adsorbed ATP is at the periphery of the medium cages, i.e., in the proximity of Cr₃ clusters (FIG. 1E). Referring to FIG. 1E, the yellow envelopes indicate the electron density distribution attributed to partially occupied positions in the pores by ATP. The grey framework structure indicates the MTN zeotype architecture of MIL-101(Cr) (each of the vertices represents the center of a super-tetrahedron) with 2 medium cages and 2 large cages. The small pores within the super-tetrahedra and the larger cages do not show detectable extra-framework electron density, suggesting a lower occupancy by ATP.

Evidence for how ATP adsorbs onto MIL-101(Cr) can be obtained by solid-state 31P NMR, which is sensitive to the local chemical environments of the three distinct phosphate groups of ATP. Solid-state 31P MAS NMR of crystalline ATP show the terminal γ-, the α-, and the β-phosphates exhibiting distinct resonances at −8, −12, and −23 ppm, respectively, in agreement with previous reports (not shown). The close proximity of adsorbed ATP to paramagnetic Cr(III) moieties in the MIL-101(Cr) framework is expected to result in rapid spin-lattice relaxation (T1) of the 31P nuclear spins and, in some cases, broadening of the 31P NMR signals.

The morphology of MIL-101(Cr) was maintained after ATP adsorption (compare FIG. 2A-with FIG. 2B). EDS, XPS and DRIFTS was used in an attempt to detect the ATP adsorption. The P/Cr ratio determined from EDS analysis corresponds to 0.19 ATP molecules per Cr₃ cluster, which agrees with the adsorption results in FIG. 1B (0.18). XPS wide-scan and the P2p and P2s spectra of the MIL-101(Cr) and ATP-loaded MIL-101(Cr) were performed. Although not shown, peaks corresponding to P, at 133.6 eV and 191.2 eV, appeared after the ATP adsorption. The Cr peaks of MIL-101(Cr) did not show significant shift after the ATP adsorption, possibly due to the small fraction (6% based on the ICP and EDS results) of the Cr(III) interacting with ATP molecules. In an attempt to confirm the coordination of ATP to Cr(III), DRIFTS data of MIL-101(Cr) before and after the adsorption of ATP were collected. In previous studies, the peaks at 1630 cm⁻¹ and 1405 cm⁻¹ were assigned to the stretching vibration peaks of O═C—O in the MIL-101(Cr) framework, while the peaks at 1018 cm⁻¹ and 745 cm⁻¹ were attributed to the vibration of the benzene rings in the skeleton of MIL-101(Cr) [29, 30]. The DRIFTS spectra did not reveal differences between MIL-101(Cr) before and after the adsorption of ATP possibly due to the low ATP loading.

Quantum chemistry simulations provide additional insights regarding the adsorption of ATP to MOFs. ATP adsorption onto two different node environments were calculated; an isolated Cr₃ (chromium trimer) cluster and an ensemble of nodes that comprise the super-tetrahedron (see, FIG. 1A). The DFT results agree with the ³¹P NMR findings that ATP is bound to Cr(III) in Cr₃ clusters through the terminal γ-phosphate, but also indicate multidentate intra-cluster binding involving the N7 of the adenosine moiety and another Cr(III) in the Cr₃ cluster. It was also discovered that the Cr-trimers at the super-tetrahedron face are close enough so that the nucleotide base, and phosphate groups can span the BDC linkers connecting the nodes (inter-cluster binding). These site ensembles have more favorable adsorption energies than bidentate adsorption on a single node. The adsorption energy for ATP on the isolated node was −100 kJ/mol as compared to −166 kJ/mol for the trimer of nodes. It was further found that ATP adsorbs through the terminal (gamma) phosphate which has been previously proposed by DFT studies to be one of the sites where Cu(II) binds [13]. Cu(II)-ATP adsorption onto the MIL-101(Cr) nodes was simulated and it was found that the gamma phosphate could bind Cu(II) and adsorb to the node through two different P═O moieties with a favorable adsorption energy of −171 kJ/mol. The adsorption of Cu(II) at the alpha and beta phosphates was also considered, which has a slightly lower adsorption energy at the node of −165 kJ/mol when referenced to the lowest energy Cu-ATP complex. Notably, the difference in energy between Cu(II) at the alpha-beta versus beta-gamma positions is small (<10 kJ/mol), indicating that the active complex can adopt multiple different configurations when coordinated to the node. It is therefore plausible that Cu(II) maintains a similar coordinating environment even when adsorbed onto MIL-101(Cr) nodes. It is noted that these are gas phase adsorption energies, and the reference state is ATP in the gas phase. ATP has considerable intra-atomic interactions including internal hydrogen bonds that incur an enthalpic penalty upon adsorption. As a result, the adsorption energies of ATP will not directly correlate to the liquid phase adsorption experiments. Moreover, these simulations do not capture the hydrolytic stability of the formed linkages in the presence of water solvent.

The ATP-loaded MIL-101(Cr) shows lower specific (per gram) amount of adsorbed N₂ (at 77K) compared to the adsorbed amount in MIL-101(Cr) (FIG. 3A). Water adsorption/desorption isotherms at 25° C. show that ATP-MIL-101(Cr) (FIG. 3C) is more hydrophilic compared to MIL-101(Cr) (FIG. 3B) and exhibits less pronounced hysteresis. Both materials remain stable after an adsorption desorption cycle, exhibiting identical isotherms in a second cycle. These results show that the ATP-loaded MIL-101(Cr) is highly porous and stable upon adsorption/desorption of water.

Having established the irreversible adsorption of ATP in or on MIL-101(Cr), the retention of the MIL-101 crystal structure, porosity and adsorption capacity, and the localization of ATP, mainly in the smaller cages, with the terminal γ-phosphate in close proximity to Cr(III), the catalytic performance of ATP-MIL-101(Cr) was assessed starting from the Diels-Alder reaction between aza-chalcone (1) and cyclopentadiene (2), which is a commonly used probe reactions. The reaction was performed in the presence of Cu(II) cations and 2-(N-morpholino)ethanesulfonic acid (MES) buffer. It was assumed that Cu(II) cations will associate with ATP so that they can coordinate with (1) in a way that either Si- or Re-face attack by (2) is favored, yielding an enantioenriched product. ICP results verified that the molar ratio of Cu(II) to ATP in MIL-101 is similar to that of the homogeneous catalyst, ca. 0.2. It was also confirmed that MES adsorbs in the MIL-101 pores. In fact, MES competes for adsorption sites with ATP limiting the highest amount of irreversibly adsorbed ATP to an ATP to Cr₃ ratio of 0.17. Therefore, it appeared that all the essential components of the catalytic system spontaneously assembled within MIL-101(Cr).

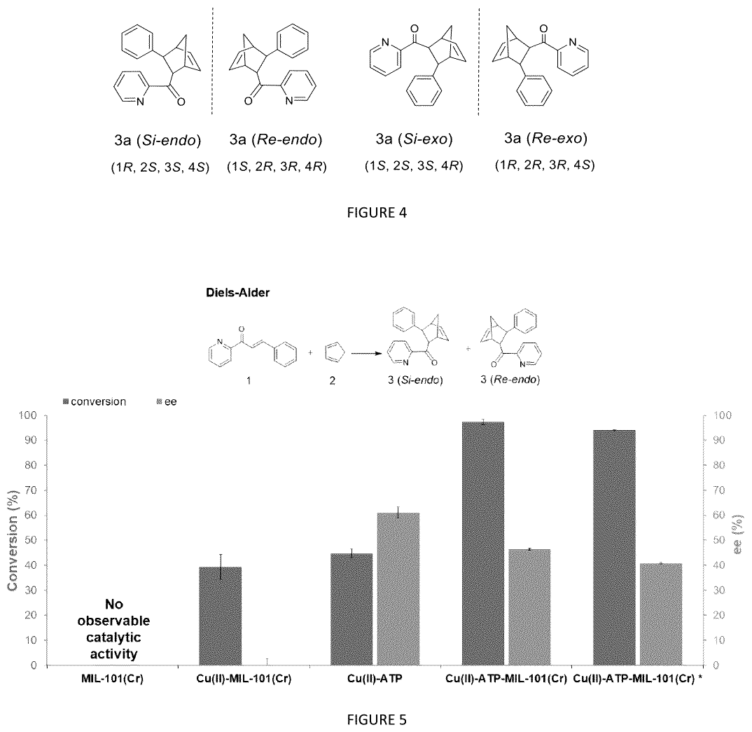

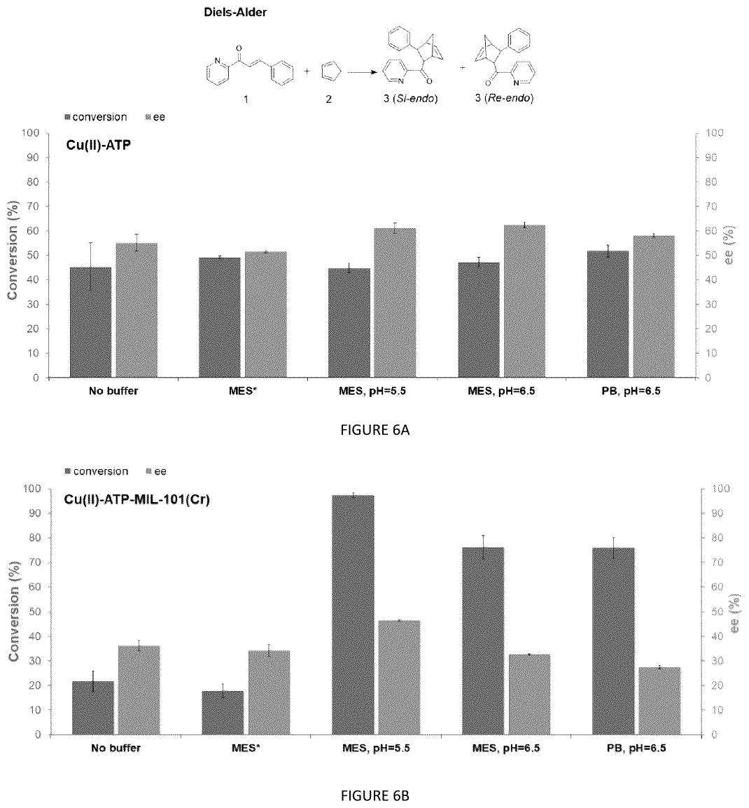

Among the four possible isomers of the product (3-phenylbicyclo[2.2.1]-hept-5-en-2-yl)(pyridin-2-yl)methanone (3): Re-endo, Si-endo, Re-exo, and Si-exo (FIG. 4), the two endo isomers were always dominant, and the enantioselectivity of the catalyst was determined by the enantiomeric excess (ee) of the Si-endo versus the Re-endo product. The Si-endo isomer is favored by the homogeneous Cu(II)-ATP catalyst reported in [13]. As shown in FIG. 5, for 3 h reaction with the homogeneous catalyst, 45% conversion with 61% ee was obtained, and at 24 h, 94% conversion and 61% ee was obtained, in agreement with previous results [13]. Under identical conditions, it was found that Cu(II)-ATP-MIL-101(Cr) achieves higher conversion (>95% vs 45%) at 3 h and lower, but still significant, selectivity (46% vs 61% ee for the Si-endo isomer). MIL-101(Cr) does not exhibit any catalytic activity, while Cu(II)-MIL-101(Cr) shows activity but no selectivity (FIG. 5). To investigate the role of assembly of the catalyst components before reaction, an alternative procedure was used and denoted by (*) in FIG. 5. It comprised first mixing MES buffer, ATP and MIL-101(Cr) followed by addition of Cu(II) cations. As shown in FIG. 5, the catalytic outcome indicates that the two catalysts exhibit similar activity and selectivity. The role of MES buffer in the catalytic activity and selectivity was also examined. In FIGS. 6A-6B, it is shown that there is an optimum pH of 5.5 for the heterogeneous catalyst (Cu(II)-ATP-MIL-101(Cr), FIG. 6B), which was accomplished by the use of a buffer consisting of MES and NaOH, while the performance of the homogeneous catalyst (Cu(II)-ATP, FIG. 6A) is less sensitive to the presence of the buffer. To further explore the substrate specificity of the homogeneous catalyst Cu(II)-ATP and the heterogenized catalyst Cu(II)-ATP-MIL-101(Cr), the Diels-Alder reactions between (1a) and (2) and (4) and (2) were investigated. For the Diels-Alder reaction between (4) and (2), as with the reaction between (1) and (2), the heterogenized Cu(II)-ATP-MIL-101(Cr) exhibits higher activity but decreased enantioselectivity, compared to the homogeneous Cu(II)-ATP under the same reaction conditions (FIG. 7). However, for the reaction between (1a) and (2), the heterogenized Cu(II)-ATP-MIL-101(Cr) exhibits both enhanced activity and selectivity (FIG. 8), demonstrating that for certain Diels-Alder reactions, the heterogenized catalyst is superior to the homogeneous one.

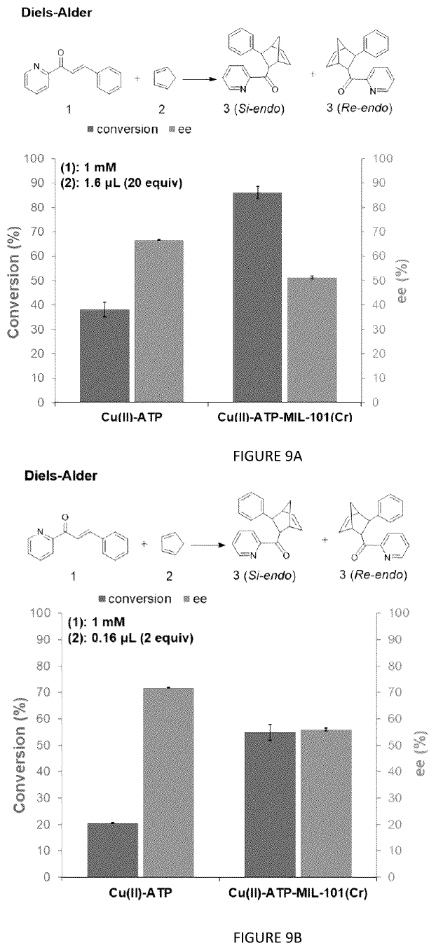

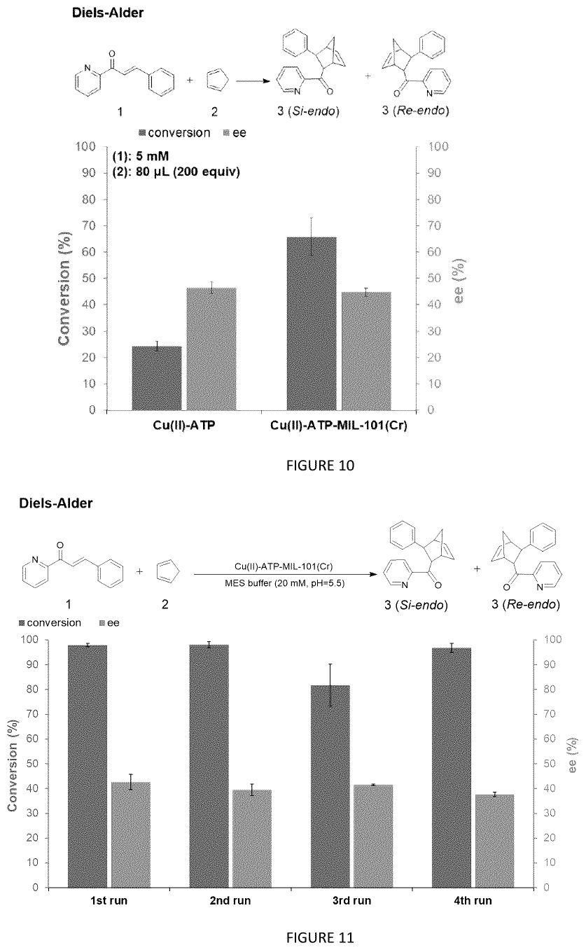

In ref. [13], a large excess of cyclopentadiene (2) to aza-chalcone (1) was used ((2)/(1)=200) (see, also FIG. 5). FIGS. 9A and 9B shows the effect of the (2)/(1) ratio on conversion and selectivity for ratios of 20 and 2, respectively. In all the cases investigated, the conversion of the heterogenized catalyst is higher at the expense of reduced enantioselectivity. FIG. 10 compares conversion and selectivity between the homogeneous and the heterogenized catalyst when using 5-fold increase of reactant concentrations (5 mM (1) and 1000 mM (2)). In this case, selectivities of the two catalysts are similar, while the heterogenized catalyst is still more active. As shown in FIG. 11, the heterogenized catalyst is reusable and fully retains its enantioselectivity.

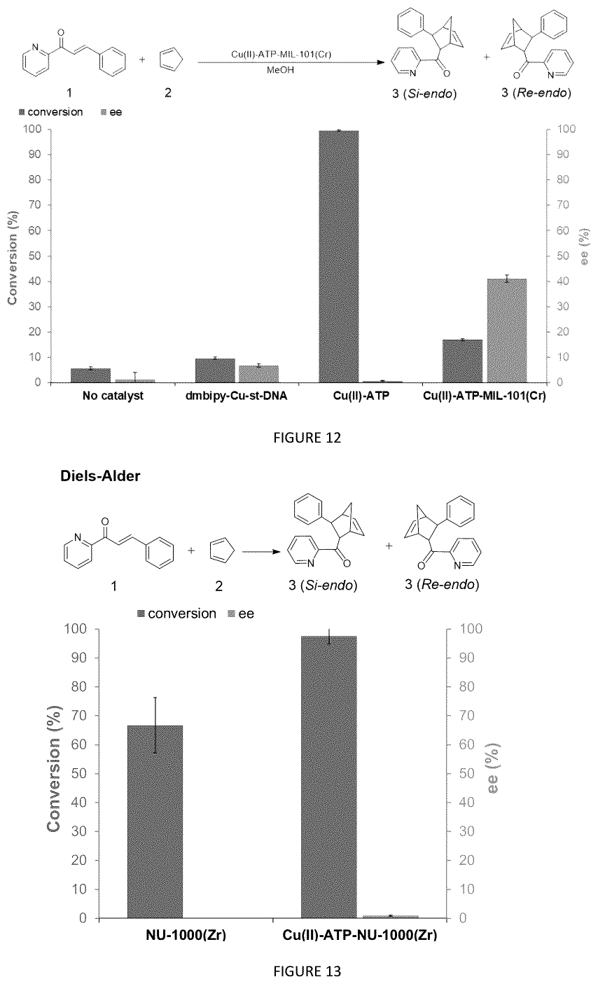

The heterogenized catalyst Cu(II)-ATP-MIL-101(Cr) also exhibits enantioselectivity when methanol is used as solvent instead of water, while a racemic product is obtained when using the homogeneous catalyst Cu(II)-ATP. In methanol, Cu(II)-ATP-MIL-101(Cr) also outperforms the original DNA ArM design introduced by Roelfes et al. [34], i.e., Cu(II) complex with 4,4′-dimethyl-2,2′-bipyridine (dmbipy-Cu) bound to salmon testes DNA (st-DNA) (FIG. 12).

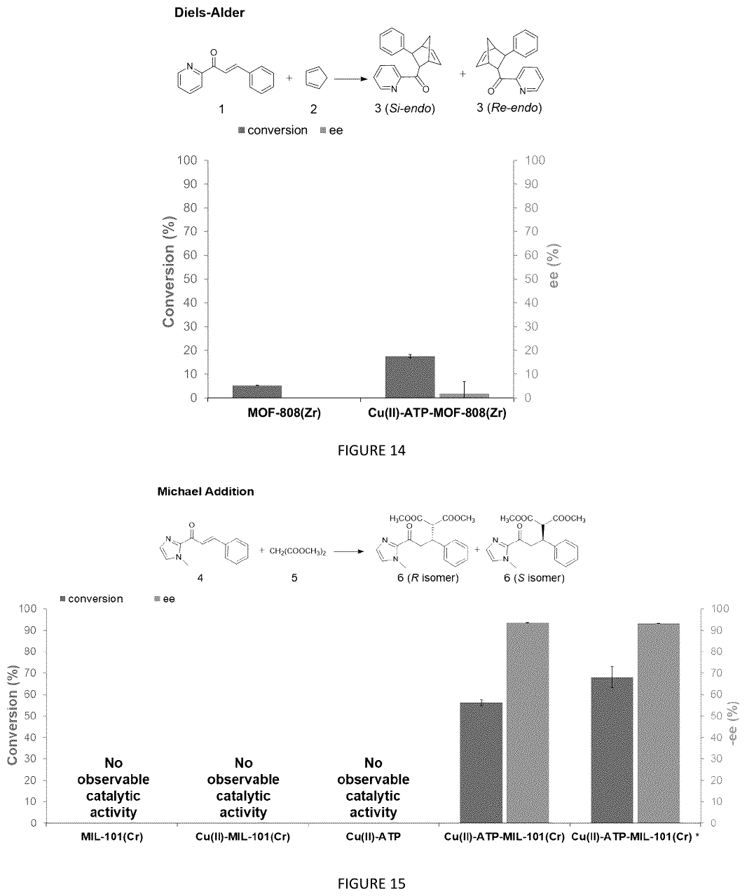

It is known that ATP can be adsorbed on other MOFs like NU-1000(Zr) [6] and MOF-808(Zr) [31]. However, NU-1000(Zr) exhibits high catalytic activity for non-enantioselective Diels-Alder reaction in the absence of Cu(II)-ATP (FIG. 13). Although MOF-808(Zr) is also inert to the Diels-Alder reaction, the heterogenous catalyst Cu(II)-ATP-MOF-808(Zr) exhibits only slightly higher activity, compared to the activity of the MOF-808(Zr), and no selectivity (FIG. 14). Other MOFs like Ni-IRMOF-74-IV [8], COFs like Tp-Azo [32] and siliceous zeolites like SPP [33] do not show ATP adsorption, while ZIF-67 [10] dissolves in the MES buffer (pH=5.5). Without being bound by theory, it appears that MIL-101(Cr) combines several important characteristics to achieve an enantioselective heterogenized ATP: (i) irreversible adsorption of ATP; (ii) retention of porosity upon ATP incorporation; (iii) inert framework towards catalysis of the reaction; (iv) affinity for the reactants; and (v) stability in reaction and regeneration conditions, including presence of buffers and extraction solvents.

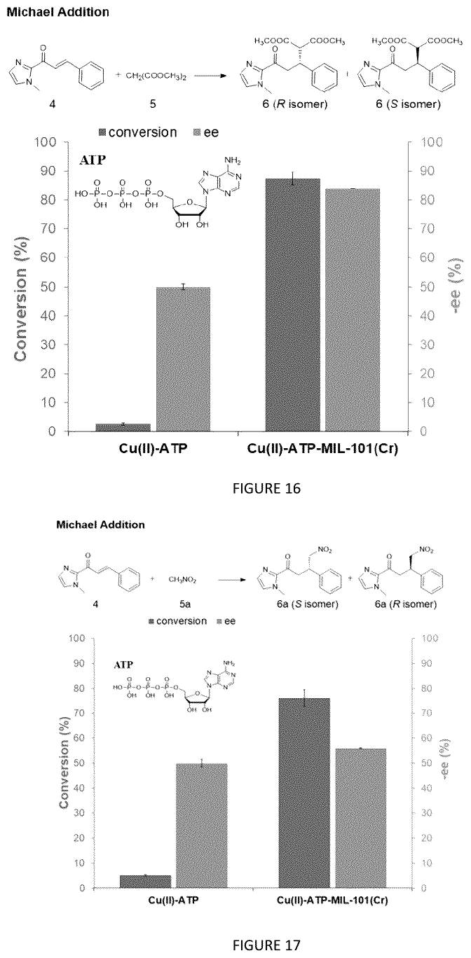

The Cu(II)-ATP-MIL-101(Cr) catalyst also showed notable enantioselective performance for the Michael addition reaction between α,β-unsaturated 2-acyl imidazole (4) and dimethyl malonate (5) with preference to the R-enantiomer product with 94% ee, while the homogeneous catalyst Cu(II)-ATP and Cu(II)-MIL-101(Cr) did not show any measurable catalytic activity (compare FIG. 15). Notably, it was found that even if the reaction was performed at room temperature instead of 4° C., 84% ee at 87% conversion was achieved using the heterogenized catalyst while at the same conditions, Cu(II)-ATP shows moderate selectivity (ca 50% ee) and very low conversion (<3%) (FIG. 16). As with the Diels-Alder reaction, catalysts prepared by adding a suspension of MIL-101(Cr) in a MES buffered Cu(II)-ATP solution and by direct mixing of ATP, MES, MIL-101(Cr) and Cu(II) show similar catalytic performance (not shown). The catalytic behavior for the Michael addition reaction between (4) and nitromethane (5a) was also determined (FIG. 17). These findings demonstrate that, for Michael addition reactions, the heterogenized catalyst can outperform the homogeneous catalyst, not only in rate, but also in enantioselectivity. They also highlight the potential of the current approach to create a new class of enantioselective heterogeneous catalysts for important reactions like Michael addition.

In addition to ATP, other nucleotides were also introduced as potential homogeneous enantioselective catalysts based on the chirality of their sugar moieties. The adsorption of ATP, guano sine triphosphate (GTP), deoxyadenosine triphosphate (dATP), adenosine diphosphate (ADP), adenosine monophosphate (AMP) and of the nucleoside adenosine (FIG. 18A) at 4° C. in the presence of MES buffer (pH=5.5) are shown in FIG. 18B, and the irreversibly adsorbed amounts remaining after 6 washings are shown in FIG. 18C. While adenosine, which does not have any phosphate groups, can be fully desorbed from MIL-101(Cr), all the nucleotides exhibit a similar level of irreversible adsorption highlighting the importance of interaction of the phosphate with the MIL-101(Cr) framework to achieve irreversible adsorption.

It is worth mentioning again that the adsorption of ATP in MES buffer (pH=5.5) (blue dots in FIG. 18B) is lower than the adsorption of ATP in water (FIG. 1B), likely due to MES molecules competing with ATP for adsorption on the MIL-101(Cr) framework.

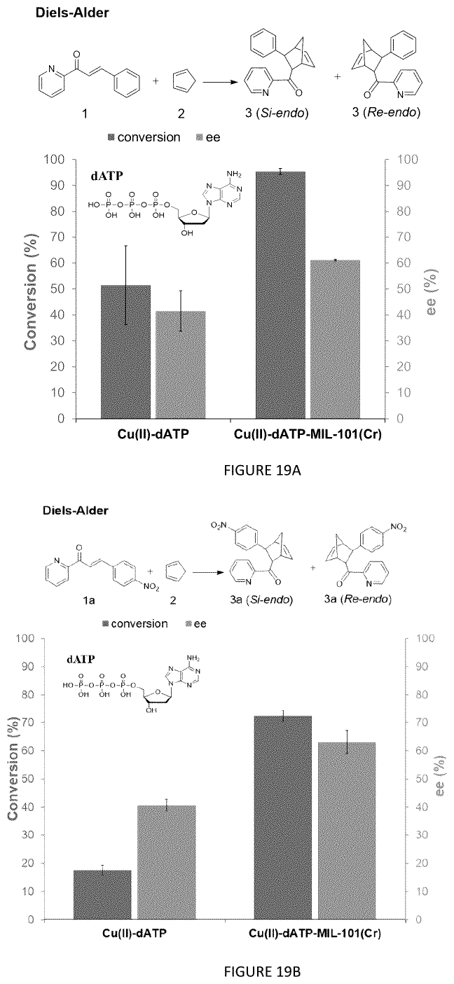

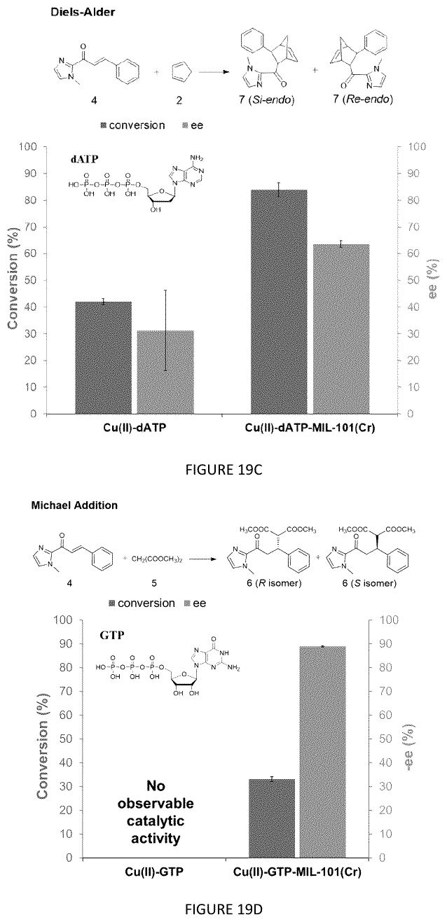

For both the Diels-Alder reaction between (1) and (2) (FIG. 19A), the Diels-Alder reaction between (1a) and (2) (FIG. 19B) and the Diels-Alder reaction between (4) and (2) (FIG. 19C), heterogenized Cu(II)-dATP-MIL-101(Cr) outperforms homogeneous Cu(II)-dATP in terms of both activity and selectivity and shows higher activity and similar enantioselectivity to Cu(II)-ATP (see “Cu(II)-ATP” in FIG. 5, FIG. 7 and in FIG. 8). This result further highlights the potential to create heterogeneous catalysts with superior performance to the homogeneous catalyst by exploring alternative nucleotides. Although Cu(II)-dATP is a worse catalyst than Cu(II)-ATP, the MIL-101(Cr)-supported Cu(II)-dATP not only outperforms the homogeneous Cu(II)-dATP but also the homogeneous Cu(II)-ATP. FIG. 19D shows that heterogenized GTP exhibits ca. 89% ee at 33% conversion while the homogeneous Cu(II)-GTP does not show measurable conversion for the Michael addition between (4) and (5), further highlighting that variation of the base and sugar provide nucleotides that upon adsorption on MOFs could exhibit superior performance to the homogeneous nucleotide-based catalyst, and in certain cases (e.g., use of MeOH as solvent), to DNA-based catalyst. Given the flexibility endowed by the availability of various natural and synthetic nucleotides, the ability to fine tune the pore structures of MOFs, and the facile attachment of the former to the later through stable (under catalytic conditions) phosphate-node linkages, MOF-supported nucleotides have the potential to become useful heterogeneous enantioselective catalysts.

### 3. Conclusion

It has been shown that artificial metalloenzymes (ArMs) based on ATP and other nucleotides can be supported on MOFs to achieve enantioselective heterogenous catalysis. For example, ATP and other nucleotides can be irreversibly bound to MIL-101(Cr), through the linkage of the terminal phosphate group in the nucleotide molecule with Cr(III) of the framework. The nucleotide-based ArMs, which combine the chiral structure of nucleotides and the catalytic activity of Cu(II) ions, after being supported on MIL-101(Cr), can function as enantioselective heterogeneous catalysts for Diels-Alder reactions and Michael addition reactions with high stability and reusability, which in certain cases exhibit significantly enhanced activity and selectivity compared to the corresponding homogeneous nucleotide-based ArMs. Using an adsorption-based method, a library of enantioselective heterogeneous catalysts can be created, for which the catalytic properties of the MOF-supported nucleotide-based ArMs can be potentially tailored by the variation of the chemical structure of base and sugar in natural and synthetic nucleotides, and by the selection of different nanoporous host with different confinement environment.

Although the foregoing subject matter has been described in some detail by way of illustration and example for purposes of clarity of understanding, it will be understood by those skilled in the art that certain changes and modifications can be practiced within the scope of the appended claims.

### REFERENCES

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.
1. Férey, G., et al., Science 309 (2005) 2040-2042.
2. Guo, Q., et al., Angewandte Chemie 57 (2018) 4926-4930.
3. Gkaniatsou, E., et al., Angewandte Chemie 57 (2018) 16141-16146.
4. Zorainy, M. Y., et al., Journal of Materials Chemistry A 9 (2021), 22159-22217.
5. Banerjee, M., et al., Journal of the American Chemical Society 131 (2009), 7524-7525.
6. Wang, S., et al., Journal of the American Chemical Society 141 (2019), 2215-2219.
7. Wang, S., et al., Journal of the American Chemical Society 139 (2017), 9827-9830.
8. Peng, S., et al., Nature communications 9 (2018), 1293.
9. Peng, S., et al., Journal of the American Chemical Society 142 (2020), 5049-5059.
10. Wang, Z., et al., Analytical Chemistry 93 (2021), 7707-7713.
11. Yao, J., et al., Bioorganic Chemistry 114 (2021), 105020.
12. Wu, X., et al., Small 17 (2021), 2007586.
13. Wang, C., et al., Nat. Commun. 11 (2020) 4792.
14. Chupas, P.J., et al., J. Appl. Crystallogr. 41 (2008) 822-824.
15. Toby, B. H., et al., J. Appl. Crystallogr. 46 (2013) 544-549.
16. Coelho, A. A., J. Appl. Crystallogr. 51 (2018) 210-218.
17. Momma, K., Izumi, F., J. Appl. Crystallogr. 41 (2008) 653-658.
18. Lebedev, O., et al., Chem. Mater. 17 (2005) 6525-6527.
19. Chung, Y.G., et al., J. Chem. Eng. Data. 64 (2019) 5985-5998.
20. Bannwarth, C., et al., WIREs. Comput. Mol. Sci. 11 (2021) e1493.
21. Bannwarth, C., et al. J. Chem. Theory and Comput. 15 (2019) 1652-1671.
22. Neese, F., WIREs. Comput. Mol. Sci. 2 (2012) 73-78.
23. Neese, F., WIREs. Comput. Mol. Sci. 8 (2018) e1327.
24. Eichkorn, K., et al., Theor. Chem. Acc. 97 (1997) 119-124.
25. Eichkorn, K., et al., Chem. Phys. Lett. 240 (1995) 283-290.
26. Grimme, S., et al., J. Chem. Phys. 132 (2010) 154104.
27. Barona, M., Snurr, R.Q., ACS Appl. Mater. Interfaces 12 (2020) 28217-28231.
28. Massiot, D., et al., Magn. Reson. Chem. 40 (2002) 70-76.
29. Zou, M., et al., Materials 15 (2022) 5066-5081.
30. Hadjiivanov, K.I., et al., Chem. Rev. 121 (2020) 1286-1424.
31. Furukawa, H., et al., J. Am. Chem. Soc. 136 (2014) 4369-4381.
32. Chandra, S., et al., J. Am. Chem. Soc. 136 (2014) 6570-6573.
33. Chandra, S., et al., J. Am. Chem. Soc. 136 (2014) 6570-6573.
34. Roelfes, G., et al., Chem. Commun., 2006, 635-637.

That which is claimed is:

1. A method for adsorbing at least one organophosphate in and/or on a parent metal-organic frameworks (MOFs), said method comprising:
contacting at least one parent MOF with an aqueous solution comprising at least one organophosphate for a time and at a temperature necessary to effectuate substantial adsorption of the at least one organophosphate in and/or on the parent MOFs to produce modified MOFs; and
washing the modified MOFs with water to remove any non-adsorbed organophosphates.

2. The method of claim 1, wherein the at least one organophosphate comprises at least one nucleotide.

3. The method of claim 1, wherein the aqueous solution further comprises at least one metal ion, which is substantially adsorbed on the parent MOFs.

4. The method of claim 1, wherein the adsorption of at least a fraction of the at least one organo-phosphate is irreversible.

5. The method of claim 1, wherein the modified MOFs comprising the irreversibly adsorbed organophosphate moieties (i) substantially retain crystallinity of the parent MOF, (ii) substantially retain an original porosity of the parent MOF, (iii) have an enhanced hydrophilicity and water stability relative to the parent MOF, or (iv) any combination of (i)-(iii).

6. The method of claim 1, wherein the at least one parent MOF is selected from the group consisting of MIL-101 and analogues thereof; MIL-100(Cr); MOF-808(Zr); PCN-333 analogues; UiO-67 and analogues thereof; Ni-BPM; INA@MOF-808(Zr); UiO-66 and analogues thereof; NU-1000 and analogues thereof; HKUST-1(Cu); Ni-IRMOF-74-IV; ZIF-67(Zr); PCN-222 analogues, and combinations thereof.

7. The method of claim 1, wherein the at least one parent MOF comprises a MIL-101 analogue.

8. The method of claim 2, wherein the at least one nucleotide comprises a species selected from the group consisting of adenosine triphosphate (ATP), guanosine triphosphate (GTP), deoxyadenosine triphosphate (dATP), adenosine diphosphate (ADP), and adenosine monophosphate (AMP), their analogues, and combinations thereof.

9. The method of claim 1, wherein the ratio of organophosphate per metal site in the modified MOF is in a range from about 0.1:1 to about 0.5:1 for irreversibly adsorbed organophosphates.

10. The method of claim 3, wherein the at least one metal ion comprises copper (II) ions.

11. The method of claim 1, wherein the time necessary to effectuate substantial adsorption of the at least one organophosphate in and/or on the parent MOFs to produce modified MOFs is in a range from about 1 h to about 24 h.

12. The method of claim 1, wherein the temperature necessary to effectuate substantial adsorption of the at least one organophosphate in and/or on the parent MOFs to produce modified MOFs is in a range from about about 1° C. to about 20° C.

13. The method of claim 4, wherein a ratio of irreversibly adsorbed organo-phosphate to MOF Cr₃ is in the range of about 0.09 to about 0.59.

14. A modified metal-organic framework (MOF) comprising at least one MOF and at least one irreversibly adsorbed organophosphate.

15. The modified MOF of claim 14, wherein the at least one irreversibly adsorbed organophosphate comprises at least one nucleotide selected from the group consisting of adenosine triphosphate (ATP), guanosine triphosphate (GTP), deoxyadenosine triphosphate (dATP), adenosine diphosphate (ADP), and adenosine monophosphate (AMP), their analogues, and combinations thereof.

16. The modified MOF of claim 14, wherein the at least one MOF comprises at least one species selected from the group consisting of MIL-101 and analogues thereof; MIL-100(Cr); MOF-808(Zr); PCN-333 analogues; UiO-67 and analogues thereof; Ni-BPM; INA@MOF-808(Zr); UiO-66 and analogues thereof; NU-1000 and analogues thereof; HKUST-1(Cu); Ni-IRMOF-74-IV; ZIF-67(Zr); PCN-222 analogues, and combinations thereof.

17. The modified MOF of claim 14, further comprising at least one metal ion adsorbed on and/or in the at least one MOF.

18. The modified MOF of claim 14, wherein a ratio of irreversibly adsorbed organo-phosphate to MOF Cr₃ is in the range of about 0.09 to about 0.59.

19. A method of using the modified MOF of claim 17 as a catalyst for enantio-selective reactions.

20. The method of claim 19, wherein the enantio-selective reaction is a Diels Alder reaction, a Michael Addition, or a Friedel-Crafts Alkylation.
